(19) United States
(12) Patent Application Publication
(10) Pub. No.: US 2024/0224086 A1
(43) Pub. Date: Jul. 4, 2024

(54) METHOD AND DEVICE FOR WIRELESS COMMUNICATION

(71) Applicants: Yu CHEN, Shanghai (CN); Xiaobo ZHANG, Shanghai (CN)

(72) Inventors: Yu CHEN, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/603,249

(22) Filed: Mar. 13, 2024

Related U.S. Application Data
(63) Continuation of application No. PCT/CN2022/118354, filed on Sep. 13, 2022.

(30) Foreign Application Priority Data
Sep. 17, 2021 (CN) 202111090152.1
Oct. 8, 2021 (CN) 202111169890.5

(51) Int. Cl. H04W 24/04; H04B 7/06; H04L 5/00; H04W 72/542

(52) U.S. Cl. CPC H04W 24/04; H04B 7/06964; H04L 5/0048; H04W 72/542

(57) ABSTRACT

The present application provides a method and device for wireless communications, comprising determining a first reference signal resource for beam selection management; determining whether a first message is transmitted on a first channel according to at least whether there exists an incomplete beam failure recovery procedure, the first message indicating the first reference signal resource; wherein a transmission of the first message is for the beam selection management. The method proposed in the present application can achieve simultaneous running of beam failure recovery and beam selection management.

### CROSS REFERENCE TO RELATED APPLICATIONS

This application is the continuation of the international patent application No. PCT/CN2022/118354, filed on Sep. 13, 2022, and claims the priority benefit of Chinese Patent Application No. 202111090152.1, filed on Sep. 17, 2021, and claims the priority benefit of Chinese Patent Application No. 202111169890.5, filed on Oct. 8, 2021, the full disclosure of which is incorporated herein by reference.

### BACKGROUND

### Technical Field

The present application relates to transmission methods and devices in wireless communication systems, and in particular to a method and device related to network optimization, multiple TRP communications, beam failure recovery, beam management, as well as layer 1 and layer 2 mobility and its related signaling in wireless communications.

### Related Art

Application scenarios of future wireless communication systems are becoming increasingly diversified, and different application scenarios have different performance demands on systems. In order to meet different performance requirements of various application scenarios, 3rd Generation Partner Project (3GPP) Radio Access Network (RAN) #72-th plenary decided to conduct a study of New Radio (NR), or what is called fifth Generation (5G). The work Item (WI) of NR was approved at 3GPP RAN #75-th plenary to standardize the NR.

In communications, whether Long Term Evolution (LTE) or 5G NR involves features of accurate reception of reliable information, optimized energy efficiency ratio, determination of information efficiency, flexible resource allocation, scalable system structure, efficient non-access layer information processing, low service interruption and aborting rate and support for low power consumption, which are of great significance to the maintenance of normal communications between a base station and a UE, reasonable scheduling of resources and balancing of system payload. Those features can be called the cornerstone of high throughout and are characterized in meeting communication requirements of various service, improving spectrum utilization and improving service quality, which are indispensable in enhanced Mobile BroadBand (eMBB), Ultra Reliable Low Latency Communications (URLLC) and enhanced Machine Type Communications (eMTC). And a wide range of requests can be found in terms of Industrial Internet of Things (IIoT), Vehicular to X (V2X) and Device to Device (D2D), Unlicensed Spectrum communications, and monitoring on UE communication quality, network plan optimization, Non Terrestrial Network (NTN) and Terrestrial Network (TN), or combined, radio resource management and multi-antenna codebook selection, as well as signaling design, neighbor management, traffic management and beamforming. Information is generally transmitted by broadcast and unicast, and both ways are beneficial to fulfilling the above requests and make up an integral part of the 5G system. The UE can be connected to the network directly or through a relay.

With the increase of scenarios and complexity of systems, higher requirements are raised for interruption rate and time delay reduction, reliability and system stability enhancement, service flexibility and power saving. At the same time, compatibility between different versions of different systems should be considered when designing the systems.

### SUMMARY

The use of multi-antenna is involved in a variety of communication scenarios, such as the use of MIMO technology, where information can be transmitted to a user through a single transmission point or through multiple transmission points (multi-TRP, multi-TRP/M-TRP, multiple transmission points or multiple transmission and reception points). Using multi-TRP may be helpful in different situations to improve throughput and expand coverage. Each TRP can support one or more beams. Multiple TRPs comprised in multi-TRP can be from a same cell identified by a physical cell identity, or from different cells identified by different physical cells. When the signal is unstable or the user moves, for example from one beam to another, beam switching is involved to ensure that the user receives or transmits data continuously. After channel quality of a beam is relatively poor, beam failure is triggered and the user terminal starts beam failure recovery procedure, which may help the user to use or activate new available beams, i.e., recovery is performed from the beam's point of view. If there are multiple ways or methods that can assist the user in selecting and determining a new beam, compatibility between these ways or methods needs to be considered, for example, if triggering conditions of these methods are satisfied at the same time or successively within a short period of time, it is necessary to solve the compatibility problem brought about by the occurrence of these methods at the same time or at a similar time, which, if not handled well, will lead to inconsistencies in the configuration of the network and the user, resulting in the interruption of the transmitting and receiving of data. At the same time, some of these methods may require network configuration, some require network confirmation, some do not even require the network to indicate activation, and some may only be done locally by the user, thus increasing the need for co-ordination, and due to the change of beams, which may involve a change of search space or a change of quasi co-located (QCL) relation of reference signals, some of which may or may not be mutually exclusive, and thus need to be handled with discretion according to the specific case to achieve a better performance and to avoid interruptions.

To address the above problem, the present application provides a solution.

It should be noted that if no conflict is incurred, embodiments in any node in the present application and the characteristics of the embodiments are also applicable to any other node, and vice versa. And embodiments in the present application and characteristics in the embodiments can be arbitrarily combined if there is no conflict.

The present application provides a method in a first node for wireless communications, comprising:
for beam selection management, determining a first reference signal resource;
determining whether a first message is transmitted on a first channel according to at least whether there exists an incomplete beam failure recovery procedure, the first message indicating the first reference signal resource;
herein, a transmission of the first message is for the beam selection management.

In one embodiment, a problem to be solved in the present application comprises: conflicts with beam selection management that may result from beam failure recovery procedure when there exists an incomplete beam failure recovery procedure.

In one embodiment, advantages of the above method comprise: determining whether to transmit a message related to beam selection management based on the existence of an incomplete beam failure recovery procedure can effectively avoid conflicts between the two based on the specific situation, and at the same time, in the absence of conflict, it can also transmit a message related to beam selection management based on the specific situation, which is conducive to the faster use of more appropriate beams.

Specifically, according to one aspect of the present application, the determining whether a first message is transmitted on a first channel being based on at least whether there exists an incomplete beam failure recovery procedure comprises: if there does not exist incomplete beam failure recovery procedure, transmitting the first message on the first channel.

Specifically, according to one aspect of the present application, a second message is transmitted, and the second message is used to indicate a second reference signal resource;

herein, the incomplete beam failure recovery procedure exists, and the transmitting a second message belongs to the incomplete beam failure recovery procedure; the determining whether a first message is transmitted on a first channel according to at least whether there exists an incomplete beam failure recovery procedure comprises: determining whether the first message is transmitted on the first channel based on whether the first reference resource and the second reference resource are non-QCL (quasi-co-located).

Specifically, according to one aspect of the present application, a first random access procedure is initiated, and the first random access procedure is based on contention; the first random access procedure comprises at least transmitting a first signal; the first signal comprises a first RACH preamble, and time-frequency resources occupied by the first RACH preamble is RACH resources associated with the second reference signal resource;

herein, the incomplete beam failure recovery procedure exists, and the first random access procedure belongs to the incomplete beam failure recovery procedure.

Specifically, according to one aspect of the present application, the incomplete beam failure recovery procedure exists, and the determining whether a first message is transmitted on a first channel based on at least whether there exists an incomplete beam failure recovery procedure comprises: determining whether the first message is transmitted on the first channel based on whether the beam selection management is applied to a first search space set; the first search space set comprises at least one search space.

Specifically, according to one aspect of the present application, a third message is received, and the third message is used to indicate a first reference signal set; the first reference signal set comprises at least one reference signal resource; first-type radio link quality is assessed according to the first reference signal set, whenever the assessed first-type radio link quality is worse than a first threshold, a first counter is increased by 1; as a response to the first counter being greater than or equal to the first value, the incomplete beam failure recovery procedure is triggered; second-type radio link quality is assessed based on the first reference signal set; third-type radio link quality is assessed based on the second reference signal set, and the first reference signal resource in the second reference signal set is determined based on at least the second-type radio link quality and the third-type radio link quality.

Specifically, according to one aspect of the present application, the first message is transmitted on the first channel based on at least whether there exists an incomplete beam failure recovery procedure; the transmitting the first message on the first channel comprises transmitting the first message on the first channel after a first time window in which the incomplete beam failure recovery procedure is completed;

herein, the incomplete beam failure recovery procedure exists.

Specifically, according to one aspect of the present application, the first message is transmitted on the first channel;

a first signaling is received, the first signaling is used to determine the first message; as a response to receiving the first signaling, the incomplete beam failure recovery procedure is canceled;

herein, the incomplete beam failure recovery procedure exists.

Specifically, according to one aspect of the present application, the first message is transmitted on the first channel;

after the first message is transmitted, a PDCCH channel scrambled with a first RNTI is not monitored on a first search space set within a second time window; the first reference signal resource is applied;

herein, the beam selection management is applied to a first search space set; the first search space set comprises at least one search space.

Specifically, according to one aspect of the present application, the first node is a UE.

Specifically, according to one aspect of the present application, the first node is an IoT terminal.

Specifically, according to one aspect of the present application, the first node is a relay.

Specifically, according to one aspect of the present application, the first node is a vehicle terminal.

Specifically, according to one aspect of the present application, the first node is an aircraft.

The present application provides a first node for wireless communications, comprising:
a first receiver, for beam selection management, determining a first reference signal resource; and
a first transmitter, determining whether a first message is transmitted on a first channel according to at least whether there exists an incomplete beam failure recovery procedure, the first message indicating the first reference signal resource;
herein, a transmission of the first message is for the beam selection management.

In one embodiment, the present application has the following advantages over conventional schemes:
it is possible to coordinate the transmission of both triggered beam failure recovery procedure and beam selection management to avoid uncertainty and confusion caused by crossing.
in the absence of conflicts, beam failure recovery and beam selection management can be supported at the same time, enabling faster activation of new beams.
when the beam failure recovery procedure and beam selection management can be mutually replaced, the completion of one can be used to terminate the other, contributing to a reduction in signaling load and a reduction in beam switching latency.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of determining a first reference signal resource and determining whether a first message is transmitted on a first channel based on at least whether there exists an incomplete beam failure recovery procedure according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of radio signal transmission according to one embodiment of the present application;

FIG. 6 illustrates a flowchart of a radio signal transmission according to one embodiment of the present application;

FIG. 7 illustrates a schematic diagram of determining whether a first message is transmitted on a first channel based on at least whether there exists an incomplete beam failure recovery procedure according to one embodiment of the present application;

FIG. 8 illustrates a schematic diagram of determining whether the first message is transmitted on the first channel based on whether beam selection management is applied to a first search space set according to one embodiment of the present application;

FIG. 9 illustrates a schematic diagram of beam selection management being applied to a first search space set according to one embodiment of the present application;

FIG. 10 illustrates a schematic diagram of a processor in a first node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of determining a first reference signal resource and determining whether a first message is transmitted on a first channel based on at least whether there exists an incomplete beam failure recovery procedure according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application determines a first reference signal resource in step 101; determines whether a first message is transmitted on a first channel according to at least whether there exists an incomplete beam failure recovery procedure in step 102;

herein, the first node for beam selection management, determines a first reference signal resource; determines whether a first message is transmitted on a first channel according to at least whether there exists an incomplete beam failure recovery procedure, the first message indicates the first reference signal resource;

herein, a transmission of the first message is for the beam selection management.

In one embodiment, the first node is a User Equipment (UE).

In one embodiment, the first node is a Mobile Station (MS).

In one embodiment, bandwidth self-adaptation is supported in 5G NR; a subset of a total cell bandwidth of a cell is called a BWP; the base station implements bandwidth self-adaptation by configuring BWPs to the UE and telling the UE which of the configured BWPs is a currently active BWP.

In one embodiment, embodiments and/or characteristics of multi-TRP comprise that a UE has multiple activated TCIs of a same BWP.

In one embodiment, implementation methods and/or characteristics of multi-TRP comprise a serving cell of a UE having two TRP links or paths.

In one embodiment, embodiments and/or characteristics of multi-TRP comprise that a same serving cell is associated with or has two different PCIs.

In one embodiment, the embodiments and/or characteristics of multi-TRP comprise that a UE is configured with multiple Component Carriers (CCs) belonging to a same serving cell, and reference signals of the multiple CCs of the same serving cell are non-QCL.

In one embodiment, embodiments and/or characteristics of multi-TRP comprise that a UE is configured with multiple CCs belonging to a same serving cell, and reference signals respectively associated with the multiple CCs of the same serving cell are non-QCL.

In one embodiment, embodiments and/or characteristics of multi-TRP comprise that a UE is configured with that at least two reference signal resources used for a radio link monitoring for a same BWP and a same serving cell are non-QCL.

In one embodiment, embodiments and/or characteristics of multi-TRP comprise that a UE is configured with that at least two reference signal indexes used for radio link monitoring for a same BWP and a same serving cell are non-QCL.

In one embodiment, embodiments and/or characteristics of multi-TRP comprise that a UE is configured with that reference signal resources identified by at least two reference signal indexes used for radio link monitoring for a same BWP and a same serving cell are non-QCL.

In one embodiment, embodiments and/or characteristics of multi-TRP comprise that a UE is configured with that at least two reference signal resources used for a beam failure detection for a same BWP and a same serving cell are non-QCL.

In one embodiment, embodiments and/or characteristics of multi-TRP comprise that a UE is configured with that at least two reference signal indexes used for a beam failure detection for a same BWP and a same serving cell are non-QCL.

In one embodiment, embodiments and/or characteristics of multi-TRP comprise that a UE is configured with that reference signal resources identified by at least two reference signal indexes used for a beam failure detection for a same BWP and a same serving cell are non-QCL.

In one embodiment, embodiments and/or characteristics of multi-TRP comprise that a UE is configured with that at least two of reference signal resources used for a beam failure detection for a same BWP and a same serving cell are non-QCL.

In one embodiment, embodiments and/or characteristics of multi-TRP comprise that a UE is configured with that at least two of reference signal indexes used for a beam failure detection for a same BWP and a same serving cell are non-QCL.

In one embodiment, embodiments and/or characteristics of multi-TRP comprise that a UE is configured with that at least two of reference signal resources identified by a reference signal index used for a beam failure detection for a same BWP and a same serving cell are non-QCL.

In one embodiment, embodiments and/or characteristics of multi-TRP comprise that a UE is configured with at least two q̅₀ for a same BWP and a same serving cell.

In one subembodiment of the embodiment, the at least two q̅₀ for a same BWP and a same serving cell are non-QCL.

In one subembodiment of the embodiment, the at least two q̅₀ for a same BWP and a same serving cell include periodic CSI-RS resource configuration indexes with same values as reference signal indexes in reference signal sets indicated by TCI-State for CORESETs used for monitoring PDCCH, and the TCI-State comprises at least two reference signal indexes having qcl-Type of ‘typeD’.

In one subembodiment of the embodiment, the at least two q̅₀ for a same BWP and a same serving cell include periodic CSI-RS resource configuration indexes with same values as reference signal indexes in reference signal sets indicated by two TCI-States for CORESETs used for monitoring at least two PDCCHs, and the two TCI-States respectively comprise at least one reference signal index having qcl-Type of ‘typeD’.

In one subembodiment of the embodiment, the at least two q̅₀ for a same BWP and a same serving cell include periodic CSI-RS resource configuration indexes with same values as reference signal indexes in reference signal sets indicated by TCI-State for at least two CORESETs used for monitoring PDCCH, and there are at least two reference signal indexes having qcl-Type of ‘typeD’ in a reference signal index indicated by the TCI-State.

In one subembodiment of the embodiment, the at least two q̅₀ for a same BWP and a same serving cell are configured through failureDetectionResourcesToAddModList.

In one embodiment, embodiments and/or characteristics of multi-TRP comprise that a UE is configured with at least two q̅₁ for a same BWP and a same serving cell.

In one subembodiment of the embodiment, the at least two q̅₁ for a same BWP and a same serving cell are non-QCL.

In one subembodiment of the embodiment, the at least two q̅₁ for a same BWP and a same serving cell are configured through a candidateBeamRSList or a candidateBeamRSListExt or a candidateBeamRSSCellList.

In one embodiment, for the specific meaning of the q̅₀, refer to chapter 6 in 3GPP TS38.213.

In one embodiment, for the specific meaning of the q̅₁, refer to chapter 6 in 3GPP TS38.213.

In one embodiment, for the specific meaning of the QCL-TypeD, refer to chapter 5.1.5 in 3GPP TS38.214.

In one embodiment, an SpCell of the first node refers to a PCell of the first node.

In one embodiment, an SpCell of the first node refers to a PSCell of the first node.

In one embodiment, a serving cell refers to a UE-camped cell; executing a cell search comprises: a UE searches for a suitable cell of a selected Public Land Mobile Network (PLMN) or a Stand-alone Non-Public Network (SNPN), selects the suitable cell to provide available traffic, and monitors a control channel of the suitable cell, and this procedure is defined as camping on a cell; that is to say, a camped cell is a serving cell of the UE relative to the UE. It has the following advantages to camp on a cell in RRC idle state or RRC inactive state: enabling the UE to receive a system message from a PLMN or an SNPN; after registration, if the UE wishes to establish an RRC connection or continue a suspended RRC connection, the UE can achieve this by executing an initial access on a control channel of the camping cell; the network may page the UE, which enables the UE to receive Earthquake and Tsunami Warning System (ETWS) and Commercial Mobile Alert System (CMAS) notifications.

In one embodiment, for a UE in RRC_CONNECTED state that is not configured with carrier aggregation/dual connectivity (CA/DC), only one serving cell comprises a primary cell; if a UE is connected to only one cell, this cell is a primary cell of the UE. For a UE in RRC_CONNECTED state configured with carrier aggregation/dual connectivity (CA/DC), a serving cell is used to indicate a cell set comprising a Special Cell (SpCell) and all sub-cells; a Primary Cell (PCell) is a cell in a Master Cell Group (MCG), the primary cell operates at a primary frequency, and the UE performs an initial connection establishment process or initiates connection reconstruction on the primary cell; for dual connectivity, there can also be Secondary Cell Group (SCG). A special cell refers to a Primary Cell (PCell) of an MCG or a Primary SCG Cell (PSCell) of an SCG; if it is not a dual connectivity operation, a special cell refers to a PCell.

In one embodiment, frequency at which a Secondary Cell (SCell) works is sub-frequency.

In one embodiment, an individual content of an information element is called a field.

In one embodiment, a Multi-Radio Dual Connectivity (MR-DC) refers to a dual connectivity between an E-UTRA and an NR node, or a dual connectivity between two NR nodes.

In one embodiment, in MR-DC, a radio access node providing a control-plane connection to the core network is a master node, and the master node may be a master eNB, a master ng-eNB, or a master gNB.

In one embodiment, an MCG refers to, in MR-DC, a group of serving cells associated with a master node, comprising a SpCell, and optionally one or multiple SCells.

In one embodiment, in MR-DC, a control plane connection to the core network is not provided, and a radio access node providing extra resources to the UE is a sub-node. The sub-node can be an en-gNB, a sub-ng-eNB or a sub-gNB.

In one embodiment, in MR-DC, a group of serving cells associated with a sub-node is a Secondary Cell Group (SCG), comprising an SpCell and, optionally, one or multiple SCells.

In one embodiment, a PCell is an SpCell of an MCG.

In one embodiment, a PSCell is an SpCell of an SCG.

In one embodiment, a TCI state is used to indicate a positive integer number of reference signal resource(s) and/or reference signal(s).

In one embodiment, a reference signal indicated by a TCI state comprises at least one of a CSI-RS, an SRS, or an SS/PBCH block.

In one embodiment, reference signal resources indicated by a TCI state comprises at least one of an index of a CSI-RS, an index of an SRS or an index of an SS/PBCH block.

In one embodiment, a TCI state is used to indicate a reference signal and/or reference signal resources whose type is QCL-TypeD.

In one embodiment, for the specific meaning of the QCL-TypeD, refer to chapter 5.1.5 in 3GPP TS38.214.

In one embodiment, a reference signal and/or reference signal resources indicated by a TCI state is used to determine a Quasi-Co-Located (QCL) parameter.

In one embodiment, a reference signal/reference signal resources indicated by a TCI state is used to determine spatial filtering.

In one embodiment, a reference signal/reference signal resources indicated by a TCI state is used to determine spatial Rx parameters.

In one embodiment, a reference signal/reference signal resources indicated by a TCI state is used to determine spatial Tx parameters.

In one embodiment, the QCL correspond to QCL-Type D.

In one embodiment, the beam selection management refers to beam adjustment that does not require triggering an explicit RRC signaling; the gNB provides to the UE through an RRC signaling measurement configurations comprising at least one of SSB and/or CSI-RS resources, an SSB and/or CSI-RS resource set, a measurement report, a triggering state used for triggering channel quality and/or interference measurement, or a triggering state used for triggering reporting channel quality and/or interference measurement result; the beam selection management is implemented at a lower layer through a control signaling at the physical layer and/or MAC layer, without requiring the RRC to know which beams are being used; SSB-based beam selection management is based on an SSB associated with an initial downlink BWP and can only be configured for the initial downlink BWP and those BWPs comprising an SSB associated with the initial downlink BWP; for other downlink BWPs, beam selection management is only executed through a CSI-RS.

In one subembodiment of the embodiment, the SSB or CSI-RS resources and a resource set correspond to the first reference signal set and/or the second reference signal set in the present application.

In one subembodiment of the embodiment, the report corresponds to a beam measurement report or a beam report.

In one subembodiment of the embodiment, the report corresponds to the first message of the present application.

In one subembodiment of the embodiment, the lower layer comprises or only comprises a physical layer.

In one subembodiment of the embodiment, the lower layer comprises a MAC layer.

In one subembodiment of the above embodiment, the measurement configuration corresponds to the third message of the present application.

In one subembodiment of the above embodiment, the measurement channel quality and/or interference correspond to the first-type radio link quality and/or the second-type radio link quality and/or the third-type radio link quality of the present application.

In one subembodiment of the above embodiment, the UE corresponds to the first node of the present application.

In one subembodiment of the above embodiment, the beam selection management also comprises activating a reference signal or activating reference signal resources based on channel quality and/or interference measurement.

In one subembodiment of the above embodiment, the beam selection management also comprises activating a TCI-State based on the channel quality and/or interference measurement.

In one subembodiment of the above embodiment, the beam selection management also comprises determining the first reference signal resource based on the channel quality and/or interference measurement.

In one subembodiment of the above embodiment, the beam selection management is based on SSB and/or CSI-RS.

In one embodiment, the beam selection management refers to beam adjustment at a lower layer not comprising beam failure recovery.

In one subembodiment of the embodiment, the lower layer comprises or only comprises a physical layer.

In one subembodiment of the embodiment, the lower layer comprises a MAC layer.

In one subembodiment of the above embodiment, the beam selection management also comprises activating TCI-State.

In one subembodiment of the above embodiment, the beam selection management also comprises applying the first reference signal resource.

In one subembodiment of the above embodiment, the beam adjustment comprises modifying an active beam or TCI-State.

In one subembodiment of the above embodiment, the beam adjustment comprises modifying a QCL relation of CORESET.

In one subembodiment of the above embodiment, the beam adjustment comprises modifying a QCL relation of CORESET to use a new beam.

In one subembodiment of the above embodiment, the beam adjustment comprises modifying a QCL relation of CORESET to use a new reference signal resource.

In one subembodiment of the above embodiment, the beam adjustment comprises replacing a currently used beam.

In one embodiment, the beam selection management is a series of operations used to adjust and/or modify QCL of at least one CORESET, but does not comprise beam failure recovery.

In one embodiment, the beam selection management is UE triggered beam adjustment based on physical-layer signaling, but does not involve beam failure recovery.

In one embodiment, the beam selection management is UE triggered beam adjustment based on physical-layer signaling and MAC-layer signaling, but does not involve beam failure recovery.

In one embodiment, the beam adjustment comprises adding or modifying at least one QCL relation of a CORESET.

In one embodiment, the beam adjustment comprises adding or modifying at least one QCL relation of a CORESET to use a new beam.

In one embodiment, the beam adjustment comprises adding or modifying at least one QCL relation of a CORESET to use new reference signal resources.

In one embodiment, the beam adjustment comprises adding or modifying a TCI state.

In one embodiment, the beam adjustment comprises activating a TCI state.

In one embodiment, the beam adjustment comprises applying new or candidate reference signal resources for channel quality evaluation.

In one embodiment, the beam selection management comprises measuring a reference signal for beam selection management.

In one embodiment, the beam selection management comprises beam selection.

In one embodiment, the beam selection management is or comprises beam management.

In one embodiment, the beam selection management comprises beam activation.

In one embodiment, the beam selection management is used for mobility management.

In one embodiment, the beam selection management is used to change a quasi co-located (QCL) CSI-RS of a currently active TCI.

In one embodiment, the beam selection management is used to change a currently active TCI.

In one embodiment, the beam selection management is or comprises beam refinement.

In one embodiment, the beam selection management is or comprises beam tracking.

In one embodiment, the beam selection management is or comprises: beam selection or activation based on beam management and/or report initiated by the first node and the network is not required to perform beam indication and activation.

In one embodiment, the beam selection management is or comprises: downlink or uplink/downlink beam selection initiated by the first node, and the selected beam is reported through a beam report triggered by the first node.

In one subembodiment of the above embodiment, the beam report comprises UCI, MAC CE, uplink CG (configured grant), type 1/type 2 CBRA (content based random access)/CFRA (content free random access).

In one subembodiment of the above embodiment, the beam report comprises a beam report of network configuration.

In one embodiment, the beam selection management is or comprises: a beam reported by a beam report of the first node is automatically activated as an active TCI or a spatial relation reference signal without the need of network activation commands.

In one embodiment, the beam selection management does not comprise beam failure recovery.

In one embodiment, the beam selection management is triggered by a reason other than BFI_COUNTER.

In one embodiment, the beam selection management is triggered when a measurement result of a given reference signal resource is below a certain threshold.

In one subembodiment of the embodiment, the given reference signal resource comprises an SSB.

In one subembodiment of the embodiment, the given reference signal resources comprise a CSI-RS.

In one subembodiment of the embodiment, the measurement result of the given reference signal resource is or comprises SS-RSRP.

In one subembodiment of the embodiment, the measurement result of the given reference signal resource is or comprises CSI-RSRP.

In one subembodiment of the embodiment, the measurement result of the given reference signal resource is or comprises SS-RSRQ.

In one subembodiment of the embodiment, the measurement result of the given reference signal resource is or comprises CSI-RSRQ.

In one subembodiment of the embodiment, the given threshold is determined by an internal algorithm or indicated by a serving cell.

In one embodiment, a measurement that triggers the beam selection management is a measurement other than the PDCCH hypothesis experiment.

In one embodiment, an indication from the physical layer to the MAC layer that triggers the beam selection management does not comprise a beam failure indication.

In one embodiment, the beam selection management is or comprises beam selection control.

In one embodiment, the beam selection management is or comprises beam activation control.

In one embodiment, the beam selection management is or comprises enhanced beam selection management.

In one embodiment, the beam selection management is or comprises enhanced beam activation control or enhanced beam selection control.

In one embodiment, a measurement result threshold that triggers the beam selection management is greater than a measurement result threshold that triggers beam failure.

In one embodiment, the determining a first reference signal resource comprises determining an index of the first reference signal resource.

In one embodiment, the first reference signal resource is or comprises an SSB.

In one embodiment, the first reference signal resource is or comprises a CSI-RS.

In one embodiment, the first reference signal resource is or comprises resources occupied by an SSB.

In one embodiment, the first reference signal resource is or comprises resources occupied by a CSI-RS.

In one embodiment, the first reference signal resource is or comprises SSB-index.

In one embodiment, the first reference signal resource is or comprises CSI-RS-index.

In one embodiment, the first channel comprises a Physical Uplink Control Channel (PUCCH).

In one embodiment, the first channel comprises a Physical Uplink Shared Channel (PUSCH).

In one embodiment, the first channel comprises a UL-SCH.

In one embodiment, the first channel comprises a logical channel.

In one embodiment, the first message is or comprises Uplink control information (UCI).

In one embodiment, the first message is or comprises an MAC CE.

In one embodiment, the first message is or comprises an RACH preamble.

In one embodiment, the first message is or comprises msg3.

In one embodiment, the first message is or comprises msgA.

In one embodiment, the first message comprises an index of the first reference signal resource.

In one embodiment, time-frequency resources occupied by the first message have a definite correspondence with the first reference signal resource, and the first signal implicitly indicates the first reference signal resources through the occupied time-frequency resources.

In one embodiment, the first message comprises an index of a configuration of the first reference signal resource.

In one embodiment, the first message comprises an identity of the first reference signal resource.

In one embodiment, the first message indicates a TCI associated with the first reference signal resource to indicate the first reference signal resource.

In one embodiment, the first message indicates a TCI state associated with the first reference signal resource to indicate the first reference signal resource.

In one embodiment, the first message indicates a CORESET associated with the first reference signal resource to indicate the first reference signal resource.

In one embodiment, the first message indicates a first parameter, and the first parameter is used to determine the first parameter signal index.

In one embodiment, the first message is part of the beam selection management.

In one embodiment, the first message is for the beam selection management.

In one embodiment, the first reference signal resource indicated by the first message belongs to or is for the beam selection management.

In one embodiment, the beam selection management triggers the first message.

In one embodiment, the beam selection management requires transmitting the first message.

In one embodiment, the incomplete beam failure recovery procedure is a beam failure recovery procedure.

In one embodiment, the failure recovery is BFR (Beam Failure Recovery).

In one embodiment, the beam failure recovery belongs to or comprises a BFR.

In one embodiment, the beam failure recovery comprises a series of actions for beam failure recovery.

In one embodiment, the beam failure recovery is used to determine a new available beam.

In one embodiment, the first message is the beam report.

In one embodiment, the beam selection management is implemented through physical-layer measurement and physical-layer signaling.

In one subembodiment of the embodiment, the physical-layer signaling refers to beam report or report measured by the physical layer, rather than beam configuration or configuration measured by the physical layer.

In one subembodiment of the embodiment, a report of a physical-layer measurement result or the beam report or an indication of a reference signal involved in the beam selection management is only implemented through a physical-layer signaling.

In one embodiment, the first message is a physical-layer signaling.

In one embodiment, beam failure recovery is a process or procedure when beam failure recovery for a serving cell and/or beam is triggered and not cancelled and a candidate beam assessment for the serving cell and/or beam has been completed, if UL-SCH resources are available for a new transmission and UL-SCH resources can carry a MAC CE and a corresponding sub-header associated with beam failure recovery, the multiplexing and assembling procedure of a MAC entity is notified to generate the MAC CE related to beam failure recovery, otherwise a scheduling request for a beam failure recovery for the serving cell and/or beam is triggered.

In one embodiment, the first node receives a third message, and the third message is used to indicate the first reference signal set; the first reference signal set comprises at least one reference signal resource; first-type radio link quality is assessed according to the first reference signal set, whenever the assessed first-type radio link quality is worse than a first threshold, a first counter is increased by 1; as a response to the first counter being greater than or equal to the first value, the incomplete beam failure recovery procedure is triggered; second-type radio link quality is assessed based on the first reference signal set; third-type radio link quality is assessed based on the second reference signal set, and the first reference signal resource in the second reference signal set is determined based on at least the second-type radio link quality and the third-type radio link quality.

In one subembodiment of the embodiment, the third message comprises an RRC message.

In one subembodiment of the embodiment, the third message comprises a MAC CE message.

In one subembodiment of the embodiment, the third message is RRCReconfiguration.

In one subembodiment of the embodiment, the third message is or comprises RadioLinkMonitoringConfig.

In one subembodiment of the embodiment, the beam measurement comprises assessing second-type radio link quality at least based on the first reference signal set.

In one subembodiment of the embodiment, the beam measurement comprises assessing third-type radio link quality at least based on the second reference signal set.

In one subembodiment of the embodiment, the third message comprises the second reference signal set.

In one subembodiment of the embodiment, the third message indicates the second reference signal set.

In one subembodiment of the embodiment, the third message indicates whether any reference signal resource in the first reference signal set belongs to the second reference signal set.

In one subembodiment of the embodiment, the third message indicates the first reference signal set by indicating an index of any reference signal in the first reference signal set.

In one subembodiment of the embodiment, the third message indicates the second reference signal set by indicating an index of any reference signal in the second reference signal set.

In one subembodiment of the embodiment, the second reference signal set comprises at least one reference signal resource.

In one subembodiment of the embodiment, the second reference signal set is a subset of the first reference signal set.

In one subembodiment of the embodiment, the second reference signal set is orthogonal to the first reference signal set.

In one subembodiment of the embodiment, there exists a QCL relation between any reference signal resource in the second reference signal set and at least one reference signal resource in the first reference signal set.

In one subembodiment of the embodiment, there exists a QCL relation between any reference signal resource in the second reference signal set and any reference signal resource in the first reference signal set.

In one embodiment, any reference signal resource in the first reference signal set is a synchronization signal block or synchronization signal/PBCH block (SSB) or Channel State Information-Reference Signal (CSI-RS) resource.

In one embodiment, an index of each reference signal resource in the first reference signal set is an ssb-index or a csi-rs-index.

In one embodiment, a set consists of indexes of all reference signal resources in the first reference signal set is a first reference signal index set.

In one embodiment, the third message indicates the first reference signal index set.

In one embodiment, the second reference signal set only comprises a CSI-RS.

In one embodiment, the second reference signal set only comprises a CSI-RS index.

In one embodiment, the second reference signal set only comprises CSI-RS resources or only comprises resources occupied by a CSI-RS.

In one embodiment, any reference signal resource comprised in the first reference signal set is associated with a first PCI.

In one embodiment, at least partial reference signal resources comprised in the first reference signal set are only associated with a first PCI; at least partial reference signal resources comprised in the first reference signal set are only associated with a second PCI.

In one embodiment, each reference signal index in the first reference signal index set indicates a reference signal resource, and the reference signal resource is an SSB or a CSI-RS resource, and reference signal resources identified by any reference signal index in the first reference signal index set belong to the first reference signal set.

In one embodiment, each reference signal index in the first reference signal index set identifies a reference signal resource, and the reference signal resource is an SSB resource or a CSI-RS resource.

In one embodiment, each reference signal index in the first reference signal index set identifies a reference signal resource, and the reference signal resource is a resource occupied by an SSB resource or a resource occupied by a CSI-RS resource.

In one embodiment, the csi-rs-index indicates a NZP-CSI-RS-ResourceId.

In one embodiment, the SSB is a synchronization signal block.

In one embodiment, the SSB is a synchronization signal/PBCH block (SS/PBCH block).

In one embodiment, any reference signal index in the first reference signal index set is a non-negative integer.

In one embodiment, any reference signal index in the first reference signal index set is a structure.

In one embodiment, any reference signal index in the first reference signal index set is a structure comprising a non-negative integer.

In one embodiment, any reference signal index in the first reference signal index set comprises a physical cell ID and a structure of an SSB-index.

In one embodiment, any reference signal index in the first reference signal index set comprises a physical cell ID and a structure of a csi-rs-index.

In one embodiment, any reference signal index in the first reference signal index set comprises an SSB-index.

In one embodiment, any reference signal index in the first reference signal index set comprises a csi-rs-index.

In one embodiment, any reference signal index in the first reference signal index set comprises aNZP-CSI-RS-ResourceId.

In one embodiment, any reference signal index in the first reference signal index set comprises a CSI-RS Resource Indicator (CRI).

In one embodiment, reference signal resources identified by each reference signal index in the first reference signal index set are detectionResource.

In one embodiment, reference signal resources identified by each reference signal index in the first reference signal index set are an SSB-index.

In one embodiment, reference signal resources identified by each reference signal index in the first reference signal index set are resources corresponding to or identified by or determined by an SSB-index.

In one embodiment, reference signal resources identified by each reference signal index in the first reference signal index set are a csi-rs-index.

In one embodiment, reference signal resources identified by each reference signal index in the first reference signal index set are resources corresponding to or identified by or determined by a csi-rs-index.

In one embodiment, the resources comprise at least one of time-domain frequency-domain or spatial-domain resources.

In one embodiment, a reference signal index corresponding to at least partial reference signal resources of a BWP used for multicast belongs to the first reference signal index set.

In one embodiment, the being used for multicast comprises Multicast Broadcast Service (MBS).

In one embodiment, the multicast service comprises MBS.

In one embodiment, the being used for multicast comprises Point to Multipoint (PTM).

In one embodiment, reference signal resources comprised in the first reference signal set belong to a same BWP.

In one embodiment, reference signal resources comprised in the first reference signal set belong to an active BWP.

In one embodiment, any reference signal index comprised in the first reference signal index set is associated with a first PCI.

In one embodiment, at least partial reference signal indexes comprised in the first reference signal index set are only associated with the second PCI.

In one embodiment, any reference signal index comprised in the first reference signal index set is only associated with a PCI.

In one embodiment, the first threshold is Qout_LR.

In one embodiment, the first threshold is determined by reception quality of a PDCCH (physical downlink control channel).

In one embodiment, the first threshold corresponds to RSRP of a radio link when a BLER of an assumed PDCCH is 10%.

In one embodiment, the first threshold corresponds to a radio link observation quality or the first-type radio link quality when BLER of a PDCCH is 10%.

In one embodiment, the first threshold corresponds to radio link quality or the first-type radio link quality when BLER of an assumed PDCCH is 10%.

In one subembodiment of the above embodiment, assuming that a PDCCH channel is transmitted on reference signal resources of the first reference signal set, a measured or theoretical result of reference signal resources of the first reference signal set when reception quality of the PDCCH is when BLER (block error rate) equal to 10% is the first threshold value.

In one subembodiment of the above embodiment, when a measured result of reference signal resources in the first reference signal set is the first threshold, a PDCCH is transmitted on reference signal resources of the first reference signal set, then BLER of the transmitted PDCCH is equal to 10%.

In one subembodiment of the above embodiment, assuming that a PDCCH is transmitted on a resource block to which reference signal resources of the first reference signal set belong, a measured or theoretical result of reference signal resources when reception quality of the PDCCH is when BLER equal to 10% is the first threshold value.

In one subembodiment of the above embodiment, when a measured result of reference signal resources in the first reference signal set is the first threshold, a PDCCH is transmitted on a resource block to which reference signal resources of the first reference signal set belong, then a BLER of the transmitted PDCCH is equal to 10%.

In one subembodiment of the above embodiment, the first threshold is an observed or theoretical result of reference signal resources in the first reference signal set as determined by a hypothetical experiment for reception quality of a PDCCH channel, where the reception quality of the PDCCH channel is BLER equal to 10%.

In one embodiment, the first threshold is RSRP, and the first-type radio link quality is RSRP of reference signal resources of the first reference signal set.

In one subembodiment of the embodiment, RSRP of reference signal resources of the first reference signal set is a measured result on reference signal resources of the first reference signal set.

In one subembodiment of the embodiment, RSRP of one or all reference signal resources of the first reference signal set is an assessment result on reference signal resources of the first reference signal set.

In one embodiment, the definition of the first threshold is a level at which a downlink at which a downlink radio link under a given resource configuration in the first reference signal set cannot be reliably received, and the reliable reception refers to transmission quality corresponding to the assumed PDCCH transmission experiment when BLER is equal to 10%.

In one embodiment, the first-type radio link quality is a best one of measurement results on all reference signal resources comprised in the first reference signal set.

In one embodiment, the first-type radio link quality is a best one of L-RSRP measurement results on all reference signal resources comprised in the first reference signal set.

In one embodiment, the first-type radio link quality is a worst one of measurement results on all reference signal resources comprised in the first reference signal set.

In one embodiment, the first-type radio link quality is an average value of measurement results on all reference signal resources comprised in the first reference signal set.

In one embodiment, the first-type radio link quality is a measurement result on a reference signal resource comprised in the first reference signal set.

In one embodiment, the assessing first-type radio link quality according to a first reference signal set comprises measuring channel quality of reference signal resources of the first reference signal set to obtain the first-type radio link quality.

In one embodiment, the assessing first-type radio link quality according to a first reference signal set comprises determining PDCCH channel reception quality in the PDCCH transmission hypothesis test according to a resource configuration of the first reference signal set.

In one embodiment, the assessing first-type radio link quality according to a first reference signal set comprises determining whether a downlink radio signal can be reliably received according to reference signal resources in the first reference signal set.

In one embodiment, the assessing first-type radio link quality according to a first reference signal set comprises determining whether a downlink radio signal can be reliably received according to a configuration of reference signal resources in the first reference signal set.

In one embodiment, the assessing first-type radio link quality according to a first reference signal set comprises performing a radio channel measurement according to a configuration of reference signal resources in the first reference signal set to determine whether a downlink radio signal can be reliably received.

In one embodiment, the first counter is BFI_COUNTER.

In one embodiment, a name of the first counter comprises a BFI.

In one embodiment, the first value is configurable.

In one embodiment, the first value is configured by a serving cell of the first node.

In one embodiment, the first message indicates the first value.

In one embodiment, the first value is a positive integer.

In one embodiment, the first value is beamFailureInstanceMaxCount.

In one embodiment, the first PCI is a Physical Cell Identifier.

In one embodiment, the first PCI is a PhysCellId.

In one embodiment, the first PCI is a Physical layer cell ID.

In one embodiment, the first PCI identifies a cell.

In one embodiment, the first PCI is used to generate an SSB identifying a cell.

In one embodiment, the first PCI and an SSB of its identified cell are QCL.

In one embodiment, the first PCI is a physCellId comprised in received ServingCellConfigCommon.

In one subembodiment of the embodiment, the first PCI is a physCellId comprised in a first level sub-item of ServingCellConfigCommon received by the first node.

In one embodiment, the first PCI is a physCellId comprised in received spCellConfigCommon.

In one subembodiment of the embodiment, the first PCI is a physCellId comprised in a first level sub-item of spCellConfigCommon received by the first node.

In one embodiment, the meaning of the phrase of “whenever the assessed first-type radio link quality is worse than a first threshold” comprises: the first node assesses the first-type radio link quality according to L1 reference signal resources in reference signal resources indicated by the first reference signal set in an evaluation period, when the first-type radio link quality is worse than the first threshold, a physical layer of the first node reports a first-type indication to a higher layer of the first node.

In one subembodiment of the embodiment, the assessment period is frame.

In one subembodiment of the embodiment, the assessment period of the first-type radio link quality is 10 milliseconds.

In one subembodiment of the embodiment, the assessment period of the first-type radio link quality is n milliseconds, where n is a positive integer.

In one subembodiment of the embodiment, the assessment period is determined according to a DRX period and a measurement gap.

In one subembodiment of the above embodiment, the assessment period of the first-type radio link quality is a maximum value between a shortest radio link monitoring period and a Discontinuous Reception (DRX) period.

In one subembodiment of the above embodiment, L1 is equal to 1.

In one subembodiment of the above embodiment, L1 is equal to 2.

In one subembodiment of the embodiment, L1 is equal to a number of element(s) in the first reference signal set.

In one subembodiment of the embodiment, the first-type indication is a beam failure instance indication.

In one subembodiment of the embodiment, the first-type indication comprises a beam failure related indication.

In one subembodiment of the embodiment, the first-type indication comprises a detection of beam failure.

In one embodiment, the meaning that a reference signal is associated with a PCI comprises: the PCI is used to generate the reference signal.

In one embodiment, the meaning that a reference signal is associated with a PCI comprises: the reference signal and an SSB of a cell identified by a PCI are QCL.

In one embodiment, the meaning that a reference signal is associated with a PCI comprises: the reference signal is transmitted by a cell identified by a PCI.

In one embodiment, the meaning that a reference signal is associated with a PCI comprises: the reference signal is indicated by a configuration signaling, an RLC (Radio Link Control) bearer that the configuration signaling goes through is configured by a CellGroupConfig IE, and an SpCell configured by the CellGroupConfig IE comprises the PCI.

In one embodiment, the meaning that a reference signal resource is associated with a PCI comprises: the PCI is used to generate the reference signal resource.

In one embodiment, the meaning that a reference signal resource is associated with a PCI comprises: the PCI is used to generate a reference signal transmitted on the reference signal resource.

In one embodiment, the meaning that a reference signal resource is associated with a PCI comprises: the reference signal resource and an SSB of a cell identified by a PCI are QCL.

In one embodiment, the meaning that a reference signal resource is associated with a PCI comprises: a cell identified by the PCI transmits a reference signal on the reference signal resource.

In one embodiment, the meaning that a reference signal resource is associated with a PCI comprises: the reference signal resource is indicated by a configuration signaling, an RLC bearer that the configuration signaling goes through is configured by a CellGroupConfig IE, and an SpCell configured by the CellGroupConfig IE comprises the PCI.

In one embodiment, the meaning that a reference signal index is associated with a PCI comprises: the PCI is used to generate a reference signal identified by the reference signal index.

In one embodiment, the meaning that a reference signal index is associated with a PCI comprises: the PCI is used to generate the reference signal index.

In one embodiment, the meaning that a reference signal index is associated with a PCI comprises: the identified reference signal resources of the reference signal resource and an SSB of a cell identified by a PCI are QCL.

In one embodiment, the meaning that a reference signal index is associated with a PCI comprises: a cell identified by the PCI transmits a reference signal on reference signal resources identified by the reference signal index.

In one embodiment, the meaning that a reference signal index is associated with a PCI comprises: the reference signal index is indicated by a configuration signaling, an RLC bearer that the configuration signaling goes through is configured by a CellGroupConfig IE, and an SpCell configured by the CellGroupConfig IE comprises the PCI.

In one embodiment, the reference signal described in the above embodiment that “a reference signal is associated with a PCI” is applicable to a reference signal transmitted in reference signal resources in the first reference signal set.

In one embodiment, the reference signal resource described in the above embodiment that “a reference signal resource is associated with a PCI” is applicable to any reference signal resource in the first reference signal set.

In one embodiment, the reference signal index described in the above embodiment that “a reference signal index is associated with a PCI” is applicable to a reference signal index in the first reference signal index set.

In one embodiment, the incomplete beam failure recovery procedure is for an SpCell of the first node.

In one embodiment, the incomplete beam failure recovery procedure is for a cell identified by the first PCI of the first node.

In one embodiment, the incomplete beam failure recovery procedure is for a cell identified by the first PCI of an SpCell of the first node.

In one embodiment, the meaning of the phrase that the incomplete beam failure recovery procedure is for an SpCell of the first node comprises: the first reference signal set for assessing the first-type radio link quality is configured by an SpCell of the first node.

In one embodiment, the meaning of the phrase that the incomplete beam failure recovery procedure is for an SpCell of the first node comprises: the first reference signal set for assessing the first-type radio link quality is configured by SpCellConfig received by the first node.

In one embodiment, the meaning of the phrase that the incomplete beam failure recovery procedure is for an SpCell of the first node comprises: the first reference signal set for assessing the first-type radio link quality is configured by spCellConfigDedicated received by the first node.

In one embodiment, the meaning of the phrase that the incomplete beam failure recovery procedure is for an SpCell of the first node comprises: the first value used to trigger the first beam failure recovery is configured by SpCellConfig received by the first node.

In one embodiment, the meaning of the phrase that the incomplete beam failure recovery procedure is for an SpCell of the first node comprises: the first value used to trigger the first beam failure recovery is configured by spCellConfigDedicated received by the first node.

In one embodiment, the meaning of the phrase that the incomplete beam failure recovery procedure is for an SpCell of the first node comprises: the triggering of the first beam failure recovery belongs to radio link monitoring of an SpCell of the first node.

In one embodiment, the meaning of the phrase that the incomplete beam failure recovery procedure is for an SpCell of the first node comprises: the first beam failure recovery is configured by RadioLinkMonitoringConfig of an SpCell of the first node.

In one embodiment, the meaning of the phrase that the incomplete beam failure recovery procedure is for an SpCell of the first node comprises: the detected failed beam in the first beam failure recovery is a beam used for communications with an SpCell of the first node.

In one embodiment, the meaning of the phrase of assessing second-type radio link quality based on the first reference signal set comprises: determining the second-type radio link quality by measuring at least one reference signal resource in the first reference signal set.

In one embodiment, the meaning of the phrase of assessing second-type radio link quality based on the first reference signal set comprises: the second-type radio link quality being a measurement result of any reference signal resource in the first reference signal set.

In one embodiment, the meaning of the phrase of assessing second-type radio link quality based on the first reference signal set comprises: the second-type radio link quality being the best among measurement results of at least partial reference signal resources in the first reference signal set.

In one subembodiment of the embodiment, the measurement result of the at least partial reference signal resources is or comprises at least one of SS-RSRP, CSI-RSRP, L1-RSRP, SS-RSRQ, CSI-RSRQ or L1-RSRQ.

In one embodiment, the meaning of the phrase of assessing second-type radio link quality based on the first reference signal set comprises: the second-type radio link quality being an average of measurement results of at least partial reference signal resources in the first reference signal set.

In one subembodiment of the embodiment, a measurement result of the at least partial reference signal resources is or comprises at least one of SS-RSRP, CSI-RSRP, L1-RSRP, SS-RSRQ, CSI-RSRQ or L1-RSRQ.

In one subembodiment of the embodiment, the average of measurement results of at least partial reference signal resources is a logarithmic average or a real number average.

In one embodiment, the meaning of the phrase of assessing second-type radio link quality based on the first reference signal set comprises: the second-type radio link quality is a best one of measurement results of all reference signal resources in the first reference signal set.

In one subembodiment of the embodiment, a measurement result of the at least partial reference signal resources is or comprises at least one of SS-RSRP, CSI-RSRP, L1-RSRP, SS-RSRQ, CSI-RSRQ or L1-RSRQ.

In one subembodiment of the embodiment, the average of measurement results of at least partial reference signal resources is a logarithmic average or a real number average.

In one embodiment, the second-type radio link quality comprises at least one of SS-RSRP, CSI-RSRP, L1-RSRP, SS-RSRQ, CSI-RSRQ or L1-RSRQ.

In one embodiment, the determining the first reference signal resource comprises determining the first reference signal resource in the second reference signal set.

In one embodiment, the determining the first reference signal resource comprises determining the first reference signal resource in the second reference signal set based on at least the second-type radio link quality and the third-type radio link quality.

In one embodiment, the determining a first reference signal resource comprises selecting a best reference signal resource from measurement results based on measurement results on reference signal resources configured by the network as the first reference signal resource.

In one embodiment, the first node determines the first reference signal resource through channel measurement.

In one embodiment, the first node determines the first reference signal resource through network configuration or default configuration.

In one embodiment, the first reference signal resource is a first or any of candidate reference signal resource lists configured by the network.

In one embodiment, the first reference signal resource is a first one or any of candidate reference signal resource lists that satisfies a given threshold configured by the network, and the given threshold is configured by the network.

In one embodiment, the meaning of the phrase of assessing third-type radio link quality based on the second reference signal set comprises: determining the third-type radio link quality by measuring at least one reference signal resource in the second reference signal set.

In one embodiment, the meaning of the phrase of assessing third-type radio link quality based on the second reference signal set comprises: the third-type radio link quality is a measurement result of any reference signal resource in the second reference signal set.

In one embodiment, the meaning of the phrase of assessing third-type radio link quality based on the second reference signal set comprises: the third-type radio link quality is a best one of measurement results of at least partial reference signal resources in the second reference signal set.

In one subembodiment of the embodiment, the measurement result of the at least partial reference signal resources is or comprises at least one of SS-RSRP, CSI-RSRP, L1-RSRP, SS-RSRQ, CSI-RSRQ or L1-RSRQ.

In one embodiment, the meaning of the phrase of assessing third-type radio link quality based on the second reference signal set comprises: the third-type radio link quality is an average of measurement results of at least partial reference signal resources in the second reference signal set.

In one subembodiment of the embodiment, a measurement result of the at least partial reference signal resources is or comprises at least one of SS-RSRP, CSI-RSRP, L1-RSRP, SS-RSRQ, CSI-RSRQ or L1-RSRQ.

In one subembodiment of the embodiment, the average of measurement results of at least partial reference signal resources is a logarithmic average or a real number average.

In one embodiment, the meaning of the phrase of assessing third-type radio link quality based on the second reference signal set comprises: the third-type radio link quality is a best one of measurement results of all reference signal resources in the second reference signal set.

In one subembodiment of the embodiment, a measurement result of the at least partial reference signal resources is or comprises at least one of SS-RSRP, CSI-RSRP, L1-RSRP, SS-RSRQ, CSI-RSRQ or L1-RSRQ.

In one subembodiment of the embodiment, the average of measurement results of at least partial reference signal resources is a logarithmic average or a real number average.

In one embodiment, the third-type radio link quality comprises at least one of SS-RSRP, CSI-RSRP, L1-RSRP, SS-RSRQ, CSI-RSRQ or L1-RSRQ.

In one embodiment, the meaning of the phrase of determining the first reference signal resource in the second reference signal set based on at least the second-type radio link quality and the third-type radio link quality comprises: when the second-type radio link quality is worse than one threshold and the third-type radio link quality is better than another threshold, any reference signal resource in the second reference signal set is determined as the first reference signal resource.

In one embodiment, the meaning of the phrase of determining the first reference signal resource in the second reference signal set based on at least the second-type radio link quality and the third-type radio link quality comprises: when the second-type radio link quality is worse than one threshold and the third-type radio link quality is better than another threshold, one reference signal resource with a best measurement result in the second reference signal set is determined as the first reference signal resource.

In one embodiment, the meaning of the phrase of determining the first reference signal resource in the second reference signal set based on at least the second-type radio link quality and the third-type radio link quality comprises: when the second-type radio link quality is worse than one threshold and the third-type radio link quality is better than another threshold, a reference signal resource with a best measurement result among reference signal resources in the second reference signal set that have a QCL relation with reference signal resources in the first reference signal set is determined as the first reference signal resource.

In one embodiment, the meaning of the phrase of determining the first reference signal resource in the second reference signal set based on at least the second-type radio link quality and the third-type radio link quality comprises: when the second-type radio link quality is worse than one threshold and the third-type radio link quality is better than another threshold, a reference signal resource with a best measurement result among the reference signal resources in the second reference signal set that do not have a QCL relation with any reference signal resource in the first reference signal set is determined as the first reference signal resource.

In one embodiment, the meaning of the phrase of determining the first reference signal resource in the second reference signal set based on at least the second-type radio link quality and the third-type radio link quality comprises: when the third-type radio link quality is better than the second-type radio link quality and exceeds a certain threshold, a reference signal resource with a best measurement result in the second reference signal set is determined as the first reference signal resource.

In one embodiment, the meaning of the phrase of determining the first reference signal resource in the second reference signal set based on at least the second-type radio link quality and the third-type radio link quality comprises: when the third-type radio link quality is better than the second-type radio link quality and exceeds a certain threshold, any reference signal resource in the second reference signal set is determined as the first reference signal resource.

In one embodiment, the meaning of the phrase of determining the first reference signal resource in the second reference signal set based on at least the second-type radio link quality and the third-type radio link quality comprises: when the third-type radio link quality is better than the second-type radio link quality and exceeds a certain threshold, a reference signal resource with a best measurement result among reference signal resources in the second reference signal set that have a QCL relation with the reference signal resources in the first reference signal set is determined as the first reference signal resource.

In one embodiment, the meaning of the phrase of determining the first reference signal resource in the second reference signal set based on at least the second-type radio link quality and the third-type radio link quality comprises: when the third-type radio link quality is better than the second-type radio link quality and exceeds a certain threshold, a reference signal resource with a best measurement result among reference signal resources in the second reference signal set that do not have a QCL relation with any reference signal resource in the first reference signal set is determined as the first reference signal resource.

In one embodiment, the certain threshold, the threshold, and the another threshold in the above embodiments can be configured by a serving cell of the first node, by internal algorithms, or through predefined configurations.

In one embodiment, for specific definition and method of candidate beam assessment, refer to chapters 8.1 and 8.1A of 3GPP TS38.133.

In one embodiment, the beam selection management and the incomplete beam failure recovery are for a same serving cell.

In one embodiment, the beam selection management and the incomplete beam failure recovery are for an SpCell of the first node.

In one embodiment, the beam selection management and the incomplete beam failure recovery are for a PCell of the first node.

In one embodiment, the beam selection management and the incomplete beam failure recovery for a same beam or same reference signal resources.

In one embodiment, the beam selection management and the incomplete beam failure recovery are for a same TRP.

In one embodiment, the beam selection management and the incomplete beam failure recovery are for a same PCI.

In one embodiment, the beam selection management in the present application comprises beam selection management based on network control.

In one embodiment, the beam selection management in the present application comprises beam selection management based on a serving cell or base station or cell group control of the first node.

In one embodiment, the beam selection management in the present application comprises beam selection management initiated by the first node.

In one embodiment, the beam selection management in the present application comprises beam selection management initiated by the UE.

In one embodiment, the beam selection management procedure in the present application comprises beam selection management.

In one embodiment, the beam selection management in the present application does not belong to the beam failure detection and recovery process.

In one embodiment, the beam selection management in the present application does not belong to the beam failure detection procedure.

In one embodiment, the beam selection management in the present application does not belong to the beam failure recovery procedure.

In one embodiment, the beam selection management in the present application does not comprise: receiving a first-type indication from lower layer.

In one subembodiment of the embodiment, the first-type indication is used to indicate beam failure.

In one embodiment, the first-type indication is used to indicate beam failure.

In one embodiment, the first-type indication is related to beam failure.

In one embodiment, the first-type indication is related to radio link monitoring.

In one embodiment, the beam selection management in the present application does not comprise: as a response to receiving the first-type indication from the lower layer, starting or restarting a timer.

In one subembodiment of the embodiment, the first-type indication is used to indicate beam failure.

In one embodiment, the beam selection management in the present application does not comprise: as a response to receiving the first-type indication from the lower layer, increasing the first counter by 1.

In one subembodiment of the embodiment, the first-type indication is used to indicate beam failure.

In one subembodiment of the embodiment, the first counter is BFI_COUNTER.

In one embodiment, the beam selection management in the present application does not depend on the first-type indication.

In one embodiment, the beam selection management in the present application does not depend on whether the first counter reaches the first value.

In one embodiment, the beam selection management in the present application does not depend on the beam failure detection procedure.

In one embodiment, the beam selection management in the present application comprises beam refinement.

In one embodiment, the beam selection management in the present application comprises beam tracking.

In one embodiment, the beam selection management in the present application comprises beam adjustment.

In one embodiment, the beam selection management in the present application comprises beam level mobility.

In one embodiment, the beam selection management in the present application comprises beam handover.

In one embodiment, the beam selection management in the present application comprises beam change.

In one embodiment, the beam selection management in the present application comprises beam switch.

In one embodiment, the beam selection management in the present application comprises beam measurement.

In one embodiment, the beam selection management in the present application comprises beam reporting.

In one embodiment, the beam selection management in the present application comprises changing a QCL relation of a reference signal resource.

In one embodiment, the beam selection management in the present application comprises changing a TCI state of a physical channel.

In one embodiment, the beam selection management in the present application comprises changing a TCI state corresponding to a CORESET of a physical channel.

In one embodiment, the beam selection management in the present application comprises at least one of the following behaviors:
executing a measurement on at least one reference signal resource;
transmitting the first message in the present application;
receiving a confirmation message for the first message;
activating a TCI state according to the first message;
activating a TCI state based on the first reference signal resource;
switching a beam;
changing a TCI state.

### Embodiment 2

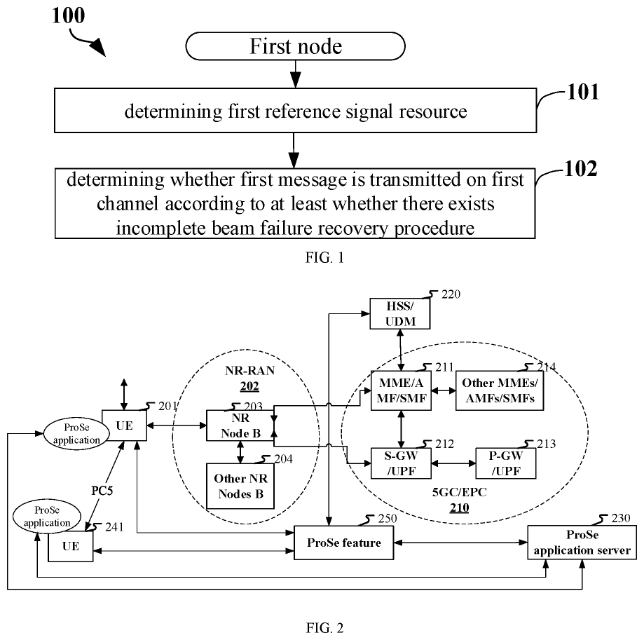

Embodiment 2 illustrates a schematic diagram of a network architecture according to one embodiment of the present application, as shown in FIG. 2. FIG. 2 is a diagram illustrating a V2X communication architecture of 5G NR, Long-Term Evolution (LTE), and Long-Term Evolution Advanced (LTE-A) systems. The 5G NR or LTE network architecture may be called a 5G System/Evolved Packet System (5GS/EPS) 200 or other appropriate terms.

The V2X communication architecture in Embodiment 2 may comprise a UE 201, a UE 241 in communication with UE 201, an NG-RAN 202, a 5G Core Network/Evolved Packet Core (5GC/EPC) 210, a Home Subscriber Server (HSS)/Unified Data Management (UDM) 220, a ProSe feature 250 and a ProSe application server 230. The V2X communication architecture may be interconnected with other access networks. For simple description, the entities/interfaces are not shown. As shown in FIG. 2, the V2X communication architecture provides packet switching services. Those skilled in the art will readily understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), satellite Radios, non-terrestrial base station communications, Satellite Mobile Communications, Global Positioning Systems (GPS), multimedia devices, video devices, digital audio players (for example, MP3 players), cameras, game consoles, unmanned aerial vehicles (UAV), aircrafts, narrow-band Internet of Things (IoT) devices, machine-type communication devices, land vehicles, automobiles, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS). If near-field communication (prose) is involved, the network architecture can also comprise network elements related to near-field communications, such as ProSe function 250, ProSe application server 230, etc. The ProSe feature 250 refers to logical functions of network-related actions needed for Proximity-based Service (ProSe), including Direct Provisioning Function (DPF), Direct Discovery Name Management Function and EPC-level Discovery ProSe Function. The ProSe application server 230 is featured with functions like storing EPC ProSe user ID, and mapping between an application-layer user ID and an EPC ProSe user ID as well as allocating ProSe-restricted code-suffix pool.

In one embodiment, the first node in the present application is a UE 201.

In one embodiment, a radio link between the UE 201 and NR node B is an uplink.

In one embodiment, a radio link between NR node B and UE 201 is a downlink.

In one embodiment, the UE 201 supports relay transmission.

In one embodiment, the UE 201 supports multicast service.

In one embodiment, the UE 201 does not support relay transmission.

In one embodiment, the UE 201 supports multi-TRP transmission.

In one embodiment, the UE 201 is a vehicle comprising a car.

In one embodiment, the gNB 203 is a base station.

In one embodiment, the gNB 203 is a base station supports multi-TRP.

In one embodiment, the gNB 203 is a base station supporting broadcast and multicast service.

In one embodiment, a DU of the gNB 203 manages a cell identified by the first PCI and a cell identified by the second PCI.

In one embodiment, the gNB 203 is a flight platform.

In one embodiment, the gNB 203 is satellite equipment.

### Embodiment 3

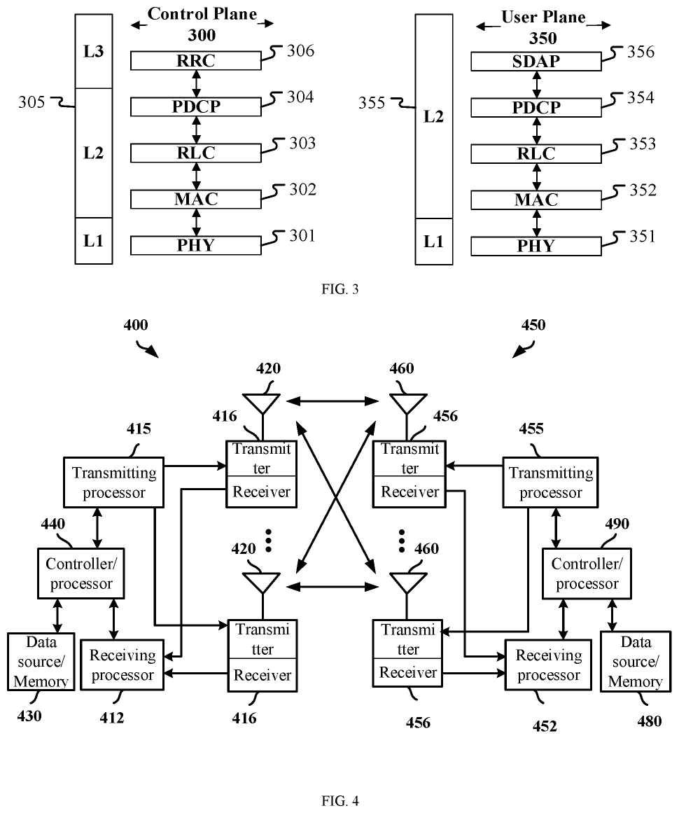

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first node (UE, gNB or a satellite or an aircraft in NTN) and a second node (gNB, UE or a satellite or an aircraft in NTN), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first node and a second node, as well as two UEs via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second node. The PDCP sublayer 304 provides multiplexing among variable radio bearers and logical channels. The PDCP sublayer 304 provides security by encrypting a packet and provides support for a first node handover between second nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second node and a first node. PC5 Signaling Protocol (PC5-S) sublayer 307 is responsible for the processing of signaling protocol at PC5 interface. The radio protocol architecture of the user plane 350 comprises layer 1 (L1) and layer 2 (L2). In the user plane 350, the radio protocol architecture for the first node and the second node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in the figure, the first node may comprise several higher layers above the L2 305. also comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the third message in the present application is generated by the RRC 306 or the MAC 302 or the PHY 301.

In one embodiment, the first message in the present application is generated by the RRC 306 or the MAC 302.

In one embodiment, the second message in the present application is generated by the RRC 306 or the MAC 302.

In one embodiment, the first signaling in the present application is generated by the RRC 306 or the MAC 302.

### Embodiment 4

Embodiment 4 illustrates a schematic diagram of a first communication device and a second communication device according to one embodiment of the present application, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the first communication device 410, a higher layer packet from the core network is provided to a controller/processor 475. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel based on radio resources allocation so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the UE 450. The higher-layer packet coming from the controller/processor 475 may be provided to the core network.

In one embodiment, the first communication device 450 comprises: at least one processor and at least one memory. The at least one memory comprises computer program codes; the at least one memory and the computer program codes are configured to be used in collaboration with the at least one processor, the first communication device 450 at least: for beam selection management, determines a first reference signal resource; determines whether a first message is transmitted on a first channel according to at least whether there exists an incomplete beam failure recovery procedure, the first message indicates the first reference signal resource; herein, a transmission of the first message is for the beam selection management.

In one embodiment, the first communication device 450 comprises at least one processor and at least one memory. a memory that stores a computer readable instruction program. The computer readable instruction program generates an action when executed by at least one processor. The action includes: for beam selection management, determining a first reference signal resource; determining whether a first message is transmitted on a first channel according to at least whether there exists an incomplete beam failure recovery procedure, the first message indicating the first reference signal resource; herein, a transmission of the first message is for the beam selection management.

In one embodiment, the first communication device 450 corresponds to a first node in the present application.

In one embodiment, the first communication device 450 is a UE.

In one embodiment, the first communication device 450 is a vehicle terminal.

In one embodiment, the first communication device 450 is a relay.

In one embodiment, the second communication device 410 is a base station.

In one embodiment, the receiver 456 (including the antenna 460), the receiving processor 452 and the controller/processor 490 are used to receive the third message in the present application.

In one embodiment, the receiver 456 (including the antenna 460), the receiving processor 452 and the controller/processor 490 are used to receive the first signaling in the present application.

In one embodiment, the transmitter 456 (including the antenna 460), the transmitting processor 455 and the controller/processor 490 are used to transmit the first message in the present application.

In one embodiment, the transmitter 456 (including the antenna 460), the transmitting processor 455 and the controller/processor 490 are used to transmit the second message in the present application.

### Embodiment 5

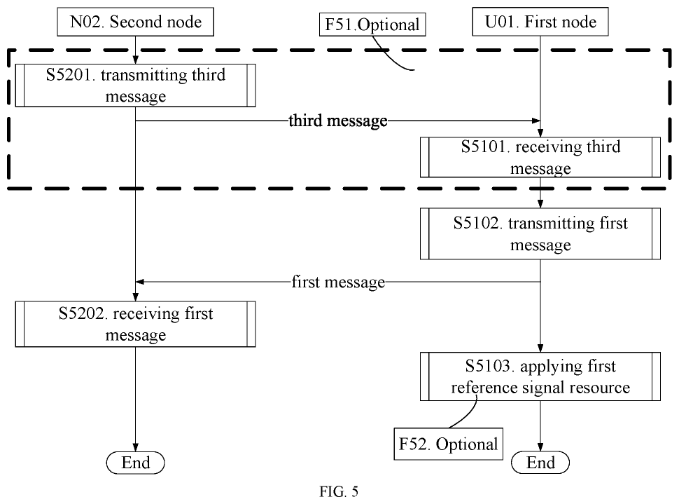

Embodiment 5 illustrates a flowchart of radio signal transmission according to one embodiment in the present application, as shown in FIG. 5. In FIG. 5, U01 corresponds to a first node of the present application, and N02 second node is a serving cell or base station of the first node. It is particularly underlined that the order illustrated in the embodiment does not put constraints over sequences of signal transmissions and implementations and steps in F51 and F52 are optional.

The first node U01 receives a third message in step S5101; transmits a first message in step S5102; applies a first reference signal resource in step S5103.

The second node N02 transmits a second message in step S5201; receives a first message in step S5202.

In embodiment 5, the first node U01, for beam selection management, determines a first reference signal resource; transmits a first message on a first signal; the first message indicates the first reference signal resource; a transmission of the first message is for the beam selection management; there does not exist an incomplete beam failure recovery procedure.

In one embodiment, the second node N02 is a serving cell of the first node U01.

In one embodiment, the second node N02 is a PCell of the first node U01.

In one embodiment, the second node N02 is an SpCell of the first node U01.

In one embodiment, the second node N02 is a PSCell of the first node U01.

In one embodiment, the second node N02 is a base station.

In one embodiment, the second node N02 is a DU.

In one embodiment, a first reference signal set is used for beam failure recovery procedure.

In one embodiment, a first reference signal set is used for beam selection management.

In one embodiment, a second reference signal set is used for beam selection management.

In one embodiment, the second node N02 indicates the first reference signal set to the first node U01.

In one subembodiment of the embodiment, the second node N02 indicates the first reference signal set through an RRC message.

In one subembodiment of the embodiment, the second node N02 indicates the first reference signal set through the third message.

In one subembodiment of the embodiment, the second node N02 indicates the second reference signal set through the third message.

In one subembodiment of the embodiment, the second node N02 indicates the first reference signal set through a MAC CE.

In one subembodiment of the embodiment, the second node N02 indicates the first reference signal set through a DCI.

In one subembodiment of the embodiment, the second node N02 indicates the first reference signal set by indicating the first reference signal index set.

In one embodiment, the second node N02 indicates the second reference signal set to the first node U01.

In one subembodiment of the embodiment, the second node N02 indicates the second reference signal set through an RRC message.

In one subembodiment of the embodiment, the second node N02 indicates the second reference signal set through a MAC CE.

In one subembodiment of the embodiment, the second node N02 indicates the second reference signal set through a DCI.

In one subembodiment of the embodiment, the second node N02 indicates the second reference signal set by indicating a second reference signal index set, and an index of any reference signal resource in the second reference signal set belongs to the second reference signal index set; reference signal resources identified by any reference signal index in the second reference signal index set belong to the second reference signal set.

In one embodiment, the second reference signal set is orthogonal to the first reference signal set.

In one embodiment, the second reference signal set at least comprises one reference signal resource.

In one embodiment, reference signal resources comprised in the second reference signal set belong to a same BWP.

In one embodiment, reference signal resources comprised in the second reference signal set belong to an active BWP.

In one embodiment, the first reference signal set belongs to an active BWP; the second reference signal set does not belong to an active BWP.

In one embodiment, the first reference signal set is used for beam failure detection.

In one embodiment, the first reference signal set is used for radio link monitoring.

In one subembodiment of the above embodiment, the radio link monitoring comprises monitoring of beam failure.

In one embodiment, the first reference signal set and the second reference signal set are not quasi co-located (QCL).

In one embodiment, the first reference signal set and the second reference signal set are QCL.

In one embodiment, any reference signal resource in the first reference signal set and any reference signal resource in the second reference signal set are not QCL.

In one embodiment, any reference signal resource in the first reference signal set is not configured by the second node N02 to be QCL with one reference signal resource in the second reference signal set.

In one embodiment, any reference signal resource in the first reference signal set and any reference signal resource in the second reference signal set are respectively QCL with different reference signal resources.

In one embodiment, an ssb-index with a QCL relation with any reference signal resource in the first reference signal index is different from an ssb-index with a QCL relation with any reference signal resource in the second reference signal set.

In one embodiment, the first reference signal set and the second reference signal set are associated with different TRPs, respectively.

In one embodiment, the first reference signal set and the second reference signal set are associated with different PCIs, respectively.

In one embodiment, the second reference signal set comprises the first reference signal resource.

In one embodiment, there exists a QCL relation between the first reference signal resource and at least one reference signal resource in the first reference signal set.

In one subembodiment of the embodiment, the first reference signal resource is a CSI-RS or a CSI-RS-index.

In one subembodiment of the embodiment, reference signal resources in the first reference signal set that have a QCL relation with the first reference signal resources are SSB or SSB-index.

In one embodiment, there does not exist a QCL relation between the first reference signal resource and any reference signal resource in the first reference signal set.

In one embodiment, the determining whether a first message is transmitted on a first channel according to at least whether there exists an incomplete beam failure recovery procedure comprises: if there does not exist incomplete beam failure recovery procedure, transmitting the first message on the first channel.

In one embodiment, the phrase of there does not exist an incomplete beam failure recovery procedure comprises: the triggered beam failure recovery procedure has been successfully completed.

In one embodiment, the phrase of there does not exist an incomplete beam failure recovery procedure comprises: the triggered beam failure recovery procedure has been canceled.

In one embodiment, the phrase of there does not exist an incomplete beam failure recovery procedure comprises: not triggering beam failure recovery procedure.

In one embodiment, after transmitting the first message in step S5102, the first node U01 monitors a PDCCH channel on the first search space set.

In one embodiment, after the first message is transmitted, the first node U01 does not monitor a PDCCH channel scrambled with a first RNTI on a first search space set within a second time window; the first node U01 applies the first reference signal resource; herein, the beam selection management is applied to a first search space set; the first search space set comprises at least one search space.

In one embodiment, the monitoring a PDCCH channel comprises blind detecting a candidate PDCCH.

In one embodiment, the monitoring a PDCCH channel comprises descrambling, decoding, and performing CRC check on a candidate PDCCH.

In one embodiment, the first node U01 determines the candidate PDCCH channel based on the first search space set.

In one subembodiment of the embodiment, the first node U01 performs a blind detection on all candidate PDCCH channels.

In one embodiment, the monitoring a PDCCH channel scrambled with a first RNTI comprises: using the first RNTI to descramble a candidate PDCCH channel.

In one embodiment, the monitoring a PDCCH channel scrambled with a first RNTI comprises: using the first RNTI to descramble and decode a candidate PDCCH channel.

In one embodiment, the monitoring a PDCCH channel scrambled with a first RNTI comprises: performing a blind detection on a candidate PDCCH channel, and the performing a blind detection comprises descrambling a CRC of received data by using the first RNTI.

In one embodiment, the monitoring a PDCCH channel scrambled with a first RNTI comprises: performing decoding on a reception bit block of a candidate PDCCH channel, using the first RNTI to descramble the decoded CRC of the bit block, and then performing check on the descrambled CRC.

In one embodiment, the not monitoring a PDCCH scrambled with a first RNTI on a first search space set within a second time window comprises: within the second time window, performing a blind detection on a PDCCH channel on the first search space set, and not correctly receive data scrambled with the first RNTI on a PDCCH channel.

In one embodiment, the not monitoring a PDCCH scrambled with a first RNTI on a first search space set within a second time window comprises: within the second time window, received data on all candidate PDCCHs does not pass CRC check.

In one embodiment, the first RNTI is or comprises a C-RNTI.

In one embodiment, the first RNTI is or comprises a CS-RNTI.

In one embodiment, the first RNTI is or comprises a G-RNTI.

In one embodiment, the first RNTI is or comprises a G-CS-RNTI.

In one embodiment, the first RNTI is or comprises a CT-RNTI

In one embodiment, the first RNTI is or comprises a T-C-RNTI.

In one embodiment, the first RNTI is an RNTI (Radio Network Temporary Identity) of the first node U01.

In one embodiment, the second node N02 indicates the second time window.

In one embodiment, the third message indicates the second time window.

In one embodiment, the second time window is measured by ms.

In one embodiment, the second time window is measured by symbol.

In one embodiment, the second time window is measured by slot.

In one embodiment, the second time window is measured by frame or 10 milliseconds.

In one embodiment, a length of the second time window comprises N time unit(s), where N is a positive integer.

In one embodiment, a length of the second time window comprises N periodic search space(s), where N is a positive integer.

In one embodiment, a length of the second time window is determined by a HARQ delay.

In one embodiment, a length of the second time window is determined by PUCCH resources.

In one embodiment, the applying the first reference signal resource comprises: setting reference signal resources in QCL information in an activated TCI-State as the first reference signal resource.

In one embodiment, the applying the first reference signal resource comprises: selecting a TCI-State of the first reference signal resource in QCL information as an active TCI-State.

In one embodiment, the applying the first reference signal resource comprises: activating reference signal resources in QCL information as a TCI-State of the first reference signal resource.

In one embodiment, the applying the first reference signal resource comprises: monitoring a PDCCH channel by using a CORESET associated with the first reference signal resource.

In one embodiment, the applying the first reference signal resource comprises: determining CORESET 0 based on the first reference signal resource.

In one embodiment, the applying the first reference signal resource comprises: using the first reference signal resource as reference signal resources for receiving a PDSCH (physical downlink shared channel).

In one embodiment, the applying the first reference signal resource comprises: replacing currently used reference signal resources with the first reference signal resource.

### Embodiment 6

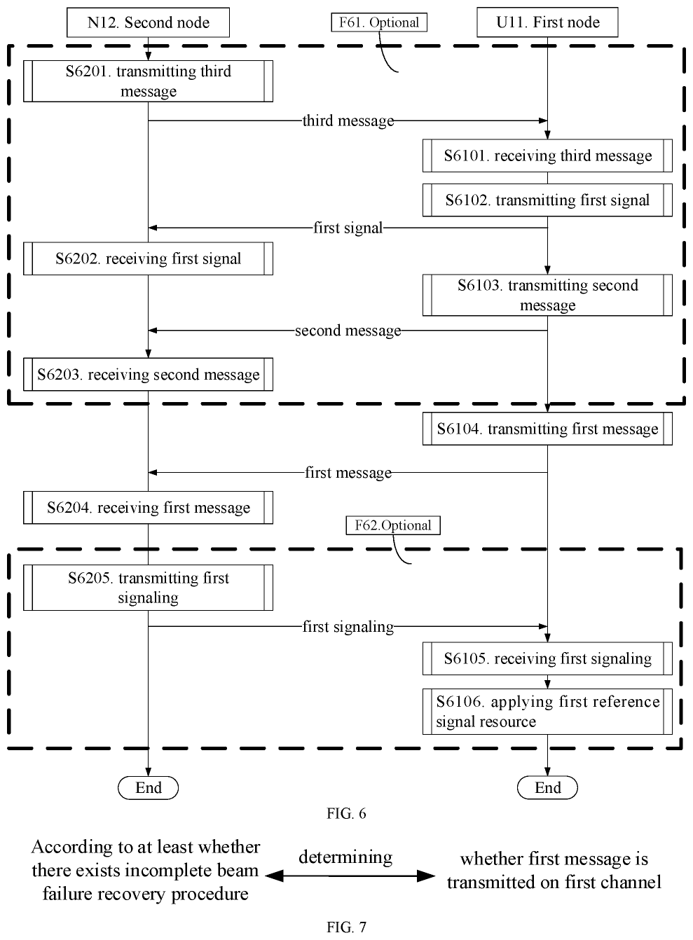

Embodiment 6 illustrates a flowchart of radio signal transmission according to one embodiment of the present application, as shown in FIG. 6. In FIG. 6, U11 corresponds to the first node of the present application, and N12 is the serving cell or base station of the first node. It is particularly underlined that the order illustrated in the embodiment does not put constraints over sequences of signal transmissions and implementations and steps in F61 and F62 are optional.

The first node U11 receives a third message in step S6101; transmits a first signal in step S6102; transmits a second message in step S6103; transmits a first message in step S6104; receives a first signaling in step S6105; applies a first reference signal resource in step S6106.

The second node N12 transmits a third message in step S6201; receives a first signal in step S6202; receives a second message in step S6203; receives a first message in step S6204; transmits a first signaling in step S6205.

In embodiment 6, the first node U11, for beam selection management, determines a first reference signal resource; transmits a first message on a first signal; the first message indicates the first reference signal resource; a transmission of the first message is for the beam selection management; there exists an incomplete beam failure recovery procedure.

In embodiment 6, for the implementation methods of the third message and a first message, refer to embodiment 1, and for the application of a first reference signal resource in the S6106, refer to embodiment 5.

In one embodiment, the second node N12 is a serving cell of the first node U11.

In one embodiment, the second node N12 is a PCell of the first node U11.

In one embodiment, the second node N12 is an SpCell of the first node U11.

In one embodiment, the second node N12 is a PSCell of the first node U11.

In one embodiment, the second node N12 is an MCG of the first node U11.

In one embodiment, the second node N12 is a base station.

In one embodiment, the second node N12 is a DU.

In one embodiment, the third message is used to indicate a first reference signal set; the first reference signal set comprises at least one reference signal resource; the first node U11 assesses first-type radio link quality according to the first reference signal set, whenever the assessed first-type radio link quality is worse than a first threshold, increases a first counter by 1; as a response to the first counter being greater than or equal to a first value, triggers the incomplete beam failure recovery procedure; assesses second-type radio link quality based on the first reference signal set; assesses third-type radio link quality based on a second reference signal set, and determines the first reference signal resource in the second reference signal set based on at least the second-type radio link quality and the third-type radio link quality.

In one embodiment, a first reference signal set is used for beam failure recovery procedure.

In one embodiment, a first reference signal set is used for beam selection management.

In one embodiment, a second reference signal set is used for beam selection management.

In one embodiment, the second node N12 indicates the first reference signal set to the first node U11.

In one subembodiment of the embodiment, the second node N02 indicates the first reference signal set through the third message.

In one embodiment, the second node N12 indicates the second reference signal set to the first node U11.

In one subembodiment of the embodiment, the second node N02 indicates the second reference signal set through an RRC message.

In one subembodiment of the embodiment, the second node N02 indicates the second reference signal set through a MAC CE.

In one subembodiment of the embodiment, the second node N02 indicates the second reference signal set through a DCI.

In one embodiment, the meaning of the phrase that the incomplete beam failure recovery procedure exists comprises: the incomplete beam failure recovery procedure has not been successfully completed.

In one embodiment, the meaning of the phrase that the incomplete beam failure recovery procedure exists comprises: the incomplete beam failure recovery procedure is in process.

In one embodiment, the meaning of the phrase that the incomplete beam failure recovery procedure exists comprises: the incomplete beam failure recovery procedure is triggered and is not canceled.

In one embodiment, the meaning of the phrase that the incomplete beam failure recovery procedure exists comprises: the incomplete beam failure recovery procedure is being suspended.

In one embodiment, the incomplete beam failure recovery procedure exists, and the transmitting a second message belongs to the incomplete beam failure recovery procedure; the determining whether a first message is transmitted on a first channel according to at least whether there exists an incomplete beam failure recovery procedure comprises: determining whether the first message is transmitted on the first channel based on whether the first reference resource and the second reference resource are non-QCL.

In one embodiment, the second message comprises a message in random access procedure.

In one embodiment, the second message comprises msg3.

In one embodiment, the second message comprises msgA.

In one embodiment, the second message comprises a MAC CE.

In one embodiment, a name of the second message comprises BFR.

In one embodiment, the second message is a part of the incomplete beam failure recovery procedure.

In one embodiment, the second message is triggered by the incomplete beam failure recovery procedure.

In one embodiment, the second message comprises an ID of the second reference signal resource.

In one embodiment, the second message comprises an index of the second reference signal resource.

In one embodiment, the second message comprises a sequence number of the second reference signal resource.

In one embodiment, the second reference signal resource is configured by the second node N12.

In one embodiment, the third message configuration comprises a third reference signal set, and the third reference signal set comprises the second reference signal resource.

In one embodiment, the second reference signal resource is configured through candidateBeamRSList, candidateBeamRSListExt, or candidateBeamRSSCellList.

In one embodiment, the second reference signal resource is or comprises an SSB.

In one embodiment, the second reference signal resource is or comprises SSB-index.

In one embodiment, the second reference signal resource is or comprises a CSI-RS.

In one embodiment, the second reference signal resource is or comprises a CSI-RS-index.

In one embodiment, when the first reference signal resource is QCL with the second reference signal resource, the first node U11 transmits the first message on the first channel.

In one embodiment, when the first reference signal resource is QCL with the second reference signal resource, the first node U11 aborts transmitting the first message on the first channel.

In one embodiment, when the first reference signal resource is not QCL with the second reference signal resource, the first node U11 transmits the first message on the first channel.

In one embodiment, when the first reference signal resource is QCL with the second reference signal resource, the first node U11 aborts transmitting the first message on the first channel.

In one embodiment, the first node U11 initiates a first random access procedure, and the first random access procedure is based on contention; the first random access procedure comprises at least transmitting a first signal; the first signal comprises a first RACH preamble, and time-frequency resources occupied by the first RACH preamble are RACH resources associated with the second reference signal resource; herein, the incomplete beam failure recovery procedure exists, and the first random access procedure belongs to the incomplete beam failure recovery procedure.

In one embodiment, the first random access procedure is CBRA.

In one embodiment, the first random access procedure comprises 2-step random access.

In one embodiment, the first random access procedure comprises 4-step random access.

In one embodiment, the first signal comprises the second message.

In one embodiment, the first signal is or comprises a first RACH preamble.

In one embodiment, the first signal is or comprises data transmitted on a PUSCH (physical uplink shared channel).

In one embodiment, the first RACH preamble is preamble.

In one embodiment, the second node N12 indicates time-frequency resources occupied by the first signal.

In one embodiment, there exists a mapping relation between the second reference signal resource and RACH resources associated with the second reference signal resource.

In one embodiment, the second node N12 indicates the second reference signal resource and RACH resources associated with the second reference signal resource.

In one embodiment, the second reference signal resource can uniquely determine RACH resources associated with the second reference signal resource.

In one embodiment, RACH resources associated with the second reference signal resource are configured by RACH-ConfigGeneric.

In one embodiment, RACH resources associated with the second reference signal resource are configured by RACH-ConfigDedicated.

In one embodiment, time-frequency resources occupied by the first RACH preamble are used to indicate the second reference signal resource.

In one embodiment, there exists a corresponding relation between time-frequency resources occupied by the first RACH preamble and the second reference signal resource.

In one embodiment, as a response to initiating the first random access procedure, the first node U11 aborts transmitting the first message.

In one embodiment, as a response to a successful completion of the first random access procedure, the first node U11 aborts transmitting the first message.

In one embodiment, the first node U11 determines to transmit the first message on the first channel based on at least whether there exists an incomplete beam failure recovery procedure.

In one subembodiment of the embodiment, if there exists an incomplete beam failure recovery procedure and the first reference signal resource is QCL with the second reference signal resource, then the first message is transmitted on the first channel.

In one subembodiment of the embodiment, if there exists an incomplete beam failure recovery procedure and the first reference signal resource is non-QCL with the second reference signal resource, then the first message is transmitted on the first channel.

In one subembodiment of the embodiment, if there exists an incomplete beam failure recovery procedure and the first reference signal resource does not change CORESET 0, then the first message is transmitted on the first channel.

In one subembodiment of the embodiment, if there exists an incomplete beam failure recovery procedure and the first reference signal resource is a reference signal resource of an inactive BWP, then the first message is transmitted on the first channel.

In one subembodiment of the embodiment, there exists an incomplete beam failure recovery procedure, and in order that RACH resources occupied by the random access process initiated by the incomplete beam failure recovery process are not QCL with the first reference signal resource, the first message is transmitted on the first channel.

In one subembodiment of the embodiment, if there exists an incomplete beam failure recovery procedure, and in order that reference signal resources associated with RACH resources occupied by a random access procedure initiated by the incomplete beam failure recovery procedure are different from the first reference signal resource, the first message is transmitted on the first channel.

In one embodiment, the first time window is measured by ms.

In one embodiment, the first time window is measured by symbol.

In one embodiment, the first time window is measured by 28 symbols.

In one embodiment, the first time window is measured by slot.

In one embodiment, the first time window is measured by frame or 10 milliseconds.

In one embodiment, a length of the first time window comprises M time unit(s), where M is a positive integer.

In one embodiment, a length of the first time window comprises M periodic search space(s), where M is a positive integer.

In one embodiment, a length of the first time window is determined by HARQ delay.

In one embodiment, a length of the first time window is determined by PUCCH resources.

In one embodiment, a completion of the incomplete beam failure recovery procedure refers to the end of the incomplete beam failure recovery procedure.

In one embodiment, a completion of the incomplete beam failure recovery procedure refers to a successful completion of the incomplete beam failure recovery procedure.

In one embodiment, a completion of the incomplete beam failure recovery procedure refers to that the incomplete beam failure recovery procedure is canceled.

In one embodiment, a completion of the incomplete beam failure recovery procedure refers to that the incomplete beam failure recovery procedure is dropped.

In one embodiment, a completion of the incomplete beam failure recovery procedure refers to a reception of feedback confirming the incomplete beam failure recovery procedure.

In one embodiment, a completion of the incomplete beam failure recovery procedure refers to a reception of a PDCCH channel scrambled by a C-RNTI.

In one embodiment, time-frequency resources of the first channel are determined by reference signal resources indicated by the incomplete beam failure recovery procedure.

In one embodiment, time-frequency resources of the first channel are associated with reference signal resources indicated by the incomplete beam failure recovery procedure.

In one embodiment, time-frequency resources of the first channel are QCL with reference signal resources indicated by the incomplete beam failure recovery procedure.

In one embodiment, advantages of the above methods are that the transmission of the first message needs to wait for the completion of the incomplete beam failure recovery procedure, and both the base station and UE confirm that the beam failure recovery procedure is completed, which is conducive to avoiding misunderstandings between the base station and UE.

In one embodiment, advantages of the above methods are that the transmission of the first message requires waiting for the completion of the incomplete beam failure recovery procedure, and using time-frequency resources associated with beam failure recovery to transmit the first message is more reliable.

In one embodiment, the first signaling is used to confirm the first message; as a response to receiving the first signaling, the incomplete beam failure recovery procedure is canceled.

In one embodiment, the first signaling is a physical-layer signaling.

In one embodiment, the first signaling comprises DCI.

In one embodiment, the first signaling is DCI.

In one embodiment, the first signaling occupies a PDCCH channel.

In one embodiment, the first signaling comprises a MAC CE.

In one embodiment, the first signaling acknowledges/responds that the first message is received.

In one embodiment, the first signaling acknowledges/responds a request for the first message.

In one embodiment, the first signaling agrees to a request of the first message.

In one embodiment, a reception of the first signaling determines a completion of the beam selection management.

In one embodiment, upon receiving the first signaling, the first node U11 assumes that the transmission of the first message is successful.

In one embodiment, upon receiving the first signaling, the first node U11 assumes that the beam selection management is successful.

In one embodiment, the canceling the incomplete beam failure recovery procedure comprises terminating the incomplete beam failure recovery procedure.

In one embodiment, the canceling the incomplete beam failure recovery procedure comprises aborting the incomplete beam failure recovery procedure.

In one embodiment, the canceling the incomplete beam failure recovery procedure comprises canceling a scheduling request triggered by the incomplete beam failure recovery procedure.

In one embodiment, the canceling the incomplete beam failure recovery procedure comprises aborting the random access procedure triggered by or comprised in the incomplete beam failure recovery procedure.

In one embodiment, the canceling the incomplete beam failure recovery procedure comprises canceling the triggered but not cancelled incomplete beam failure recovery procedure.

In one embodiment, the canceling the incomplete beam failure recovery procedure comprises canceling the suspended beam failure recovery procedure.

### Embodiment 7

Embodiment 7 illustrates a schematic diagram of determining whether a first message is transmitted on a first channel based on at least whether there exists an incomplete beam failure recovery procedure according to one embodiment of the present application, as shown in FIG. 7.

In one embodiment, if there does not exist incomplete beam failure recovery procedure, the first message is transmitted on the first channel.

In one subembodiment of the embodiment, the incomplete beam failure recovery procedure and the first message are for a same serving cell.

In one subembodiment of the embodiment, the incomplete beam failure recovery procedure and the first message are for a same PCell.

In one subembodiment of the embodiment, the incomplete beam failure recovery procedure and the first message are for a same TRP.

In one subembodiment of the embodiment, the incomplete beam failure recovery procedure and the first message are for a same reference signal set used to assess a radio channel or radio link quality.

In one subembodiment of the embodiment, the incomplete beam failure recovery procedure and the first message are for a same beam.

In one subembodiment of the embodiment, the incomplete beam failure recovery procedure and the first message are for a same PCI.

In one subembodiment of the embodiment, reference signal resources used to trigger the incomplete beam failure recovery procedure and reference signal resources used to trigger the first message have a QCL relation.

In one subembodiment of the embodiment, the incomplete beam failure recovery procedure and the beam selection management are for a same PCell.

In one embodiment, if there exists the incomplete beam failure recovery procedure, and the second reference signal resource and the first reference signal resource are not QCL, then the first message is transmitted on the first channel.

In one embodiment, if there exists the incomplete beam failure recovery procedure, and the second reference signal resource and the first reference signal resource are QCL, then the first message is transmitted on the first channel.

In one embodiment, if there exists the incomplete beam failure recovery procedure, and the second reference signal resource and the first reference signal resource are not QCL, then the first message is not transmitted on the first channel.

In one embodiment, if there exists the incomplete beam failure recovery procedure, and the second reference signal resource and the first reference signal resource are QCL, then the first message is not transmitted on the first channel.

In one embodiment, if there exists the incomplete beam failure recovery procedure, and the beam selection management is applied to a first search space set, then the first message is transmitted on the first channel; if there exists the incomplete beam failure recovery procedure, and the beam selection management is not applied to a first search space set, then the first message is not transmitted on the first channel.

In one subembodiment of the embodiment, any search space in the first search space set is associated with a CORESET with index 0.

In one subembodiment of the embodiment, any search space in the first search space set is a CSS (Common Search Space).

In one subembodiment of the embodiment, any search space in the first search space set is a Type0-PDCCH CSS set, a Type0A-PDCCH CSS set, and a Type0/0A/2-PDCCH CSS set in a Type2-PDCCH CSS set.

In one subembodiment of the embodiment, any search space in the first search space set is USS.

In one subembodiment of the embodiment, any search space in the first search space set is associated with a CORESET indexed other than 0.

In one subembodiment of the embodiment, any search space in the first search space set is not a Type0-PDCCH CSS set, nor is it a Type0A-PDCCH CSS set, nor is it a Type0/0A/2-PDCCH CSSset in a Type2-PDCCH CSS set.

In one embodiment, if there exists the incomplete beam failure recovery procedure, and the beam selection management is applied to a first search space set, then the first message is not transmitted on the first channel; if there exists the incomplete beam failure recovery procedure, and the beam selection management is not applied to a first search space set, then the first message is transmitted on the first channel.

In one subembodiment of the embodiment, any search space in the first search space set is associated with a CORESET with index 0.

In one subembodiment of the embodiment, any search space in the first search space set is CSS (Common Search Space).

In one subembodiment of the embodiment, any search space in the first search space set is a Type0-PDCCH CSS set, a Type0A-PDCCH CSS set, and a Type0/0A/2-PDCCH CSS set in a Type2-PDCCH CSS set.

In one subembodiment of the embodiment, any search space in the first search space set is USS.

In one subembodiment of the embodiment, any search space in the first search space set is associated with a CORESET indexed other than 0.

In one subembodiment of the embodiment, any search space in the first search space set is not a Type0-PDCCH CSS set, nor is it aType0A-PDCCH CSS set, nor is it a Type0/0A/2-PDCCH CSSset in a Type2-PDCCH CSS set.

### Embodiment 8

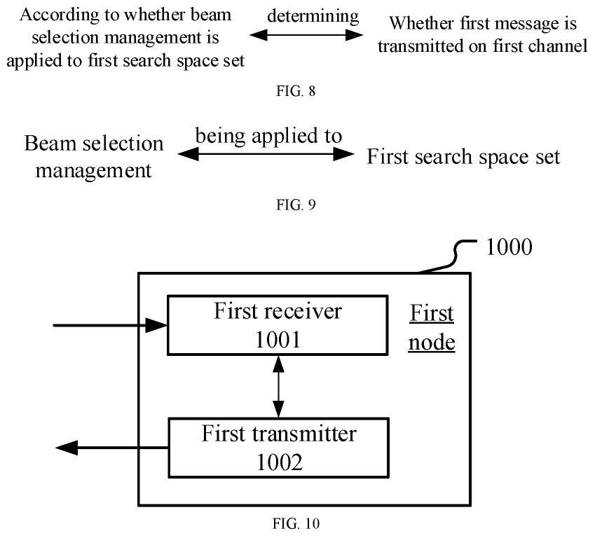

Embodiment 8 illustrates a schematic diagram of determining whether a first message is transmitted on a first channel based on whether beam selection management is applied to a first search space set according to one embodiment of the present application, as shown in FIG. 8.

In one embodiment, when the beam selection management is applied to the first search space set, the first node transmits the first message on the first channel; when the beam selection management is not applied to the first search space set, the first node does not transmit the first message on the first channel.

In one embodiment, when the beam selection management is not applied to the first search space set, the first node transmits the first message on the first channel; when the beam selection management is applied to the first search space set, the first node does not transmit the first message on the first channel.

In one embodiment, when the beam selection management is applied to the first search space set, the first node transmits the first message on the first channel; when the beam selection management is not applied to the first search space set, the first node aborts transmitting the first message.

In one embodiment, when the beam selection management is not applied to the first search space set, the first node transmits the first message on the first channel; when the beam selection management is applied to the first search space set, the first node aborts transmitting the first message.

In one embodiment, any search space in the first search space set is associated with a CORESET with index 0.

In one embodiment, any search space in the first search space set is CSS (Common Search Space).

In one embodiment, any search space in the first search space set is a Type0-PDCCH CSS set, a Type0A-PDCCH CSS set, and a Type0/0A/2-PDCCH CSS set in a Type2-PDCCH CSS set.

In one embodiment, any search space in the first search space set is USS.

In one embodiment, any search space in the first search space set is associated with a CORESET indexed other than 0.

In one embodiment, any search space in the first search space set is not a Type0-PDCCH CSS set, nor is it a Type0A-PDCCH CSS set, nor is it a Type0/0A/2-PDCCH CSS set in a Type2-PDCCH CSS set.

In one embodiment, the first reference signal resource is used to determine a monitoring occasion set for a PDCCH channel.

In one subembodiment of the embodiment, the first node monitors a PDCCH channel in the monitoring occasion set.

In one subembodiment of the embodiment, the first reference signal resource is ssb-index.

In one subembodiment of the embodiment, the first reference signal resource and MIB are used together to determine the monitoring occasion set.

In one subembodiment of the embodiment, the first node determines the first monitoring set based on the first reference signal resource through a table lookup method.

In one subembodiment of the embodiment, the monitoring occasion set corresponds to the first search space set.

In one embodiment, when beam selection management is applied to a first search space set and the monitoring occasion set used for monitoring a PDCCH changes, the first message is transmitted on the first channel; when beam selection management is applied to a first search space set and the monitoring occasion set used for monitoring a PDCCH does not change, the first message is aborted to be transmitted.

In one embodiment, when beam selection management is applied to a first search space set and the monitoring occasion set used for monitoring a PDCCH changes, the first message is aborted to be transmitted; when beam selection management is applied to a first search space set and the monitoring occasion set used for monitoring a PDCCH does not change, then the first message is transmitted on the first channel.

In one embodiment, when beam selection management is applied to a first search space set and the monitoring occasion set used to monitor CORESET 0 of a PDCCH changes, the first message is aborted to be transmitted; when beam selection management is applied to a first search space set and the monitoring occasion set used to monitor CORESET 0 of a PDCCH does not change, the first message is transmitted on the first channel.

In one embodiment, when beam selection management is applied to a first search space set and the first search space set only comprises a USS, the first message is transmitted on the first channel.

In one embodiment, when beam selection management is applied to a first search space set and the first search space set comprises a CSS of 0-th type, the first message is transmitted on the first channel.

In one embodiment, when beam selection management is applied to a first search space set, the first node transmits the first message on the first channel.

In one subembodiment of the embodiment, any search space in the first search space set is associated with a CORESET with index 0.

In one subembodiment of the embodiment, any search space in the first search space set is CSS (Common Search Space).

In one subembodiment of the embodiment, any search space in the first search space set is a Type0-PDCCH CSS set, a Type0A-PDCCH CSS set, and a Type 0/0A/2-PDCCH CSS set in a Type2-PDCCH CSS set.

In one subembodiment of the embodiment, any search space in the first search space set is USS.

In one subembodiment of the embodiment, any search space in the first search space set is associated with a CORESET indexed other than 0.

In one subembodiment of the embodiment, any search space in the first search space set is not a Type0-PDCCH CSS set, nor is it a Type0A-PDCCH CSS set, nor is it a Type0/0A/2-PDCCH CSS set in a Type2-PDCCH CSS set.

In one embodiment, when beam selection management is applied to a first search space set, the first node aborts transmitting the first message.

In one subembodiment of the embodiment, any search space in the first search space set is associated with a CORESET with index 0.

In one subembodiment of the embodiment, any search space in the first search space set is CSS (Common Search Space).

In one subembodiment of the embodiment, any search space in the first search space set is a Type0-PDCCH CSS set, a Type 0A-PDCCH CSS set, and a Type 0/0A/2-PDCCH CSS set in a Type2-PDCCH CSS set.

In one subembodiment of the embodiment, any search space in the first search space set is USS.

In one subembodiment of the embodiment, any search space in the first search space set is associated with a CORESET indexed other than 0.

In one subembodiment of the embodiment, any search space in the first search space set is not a Type0-PDCCH CSS set, nor is it a Type0A-PDCCH CSS set, nor is it a Type0/0A/2-PDCCH CSS set in a Type2-PDCCH CSS set.

In one embodiment, advantages of the above methods are that whether the incomplete beam failure recovery and beam selection management conflict with each other can be further judged through a first search space set, if there is no conflict, a first message can be transmitted; otherwise, the first message is aborted to be transmitted; this is conducive to providing comprehensive management for the UE, ensuring rapid recovery of the beam, avoiding conflicts, avoiding inconsistencies between the base station and the UE, and reducing the configuration latency.

### Embodiment 9

Embodiment 9 illustrates a schematic diagram of beam selection management being applied to a first search space set according to one embodiment of the present application, as shown in FIG. 9.

In one embodiment, the first reference signal resource determined by the beam selection management is applied to a CORESET of at least one search space in the first search space set.

In one embodiment, the first reference signal resource determined by the beam selection management is set to a CORESET to which at least one search space in the first search space set belongs.

In one embodiment, the first reference signal resource determined by the beam selection management is used to determine at least one search space in the first search space set.

In one embodiment, the first reference signal resource determined by the beam selection management is used to determine a CORESET of at least one search space in the first search space set.

In one embodiment, the first reference signal resource determined by the beam selection management is used to determine a monitoring occasion of at least one search space in the first search space set.

In one embodiment, a CORESET of any search space in the first search space set is QCL with reference signal resources determined by the beam selection management.

In one embodiment, reference signal resources of a CORESET of any search space in the first search space set is QCL with reference signal resources determined by the beam selection management.

In one embodiment, reference signal resources indicated by a TCI-State associated with a CORESET of any search space in the first search space set are QCL with reference signal resources determined by the beam selection management.

In one embodiment, the first reference signal resource is determined as a currently active TCI-State during the beam selection management procedure, and the currently active TCI-State is associated with a CORESET of the first search space set.

In one embodiment, the first search space set is a Type0-PDCCH CSS set, and a CORESET of the first search space set is determined by an index of the first reference signal resource or an RB occupied by the first reference signal resource or an RB corresponding to the first reference signal resource determined by the beam selection management.

In one subembodiment of the embodiment, a CORESET of the first search space set is determined by an index of the first reference signal resource by looking up a table.

In one subembodiment of the embodiment, the first reference signal resource is an SSB.

In one subembodiment of the embodiment, the first node does not use shared spectrum resources.

In one embodiment, the first search space set is a Type0-PDCCH CSS set, and a CORESET of the first search space set is determined by an index of the first reference signal resource and determined by a system frame number corresponding to the first reference signal resource determined by the beam selection management.

In one subembodiment of the embodiment, a CORESET of the first search space set is determined by an index of the first reference signal resource through looking up a table.

In one subembodiment of the embodiment, the first node uses shared spectrum resources.

In one subembodiment of the embodiment, the first reference signal resource is an SSB.

In one embodiment, the first reference signal resource determined by the beam selection management is associated with a monitoring occasion of Type0-PDCCH, the first node uses a shared spectrum, and the first search space set comprises a search space of Type0-PDCCH.

### Embodiment 10

Embodiment 10 illustrates a structure block diagram of a processor in a first node according to one embodiment of the present application, as shown in FIG. 10. In FIG. 10, a processor 1000 in a first node comprises a first receiver 1001 and a first transmitter 1002. In Embodiment 10,

the first receiver 1001, for beam selection management, determines a first reference signal resource;

the first transmitter 1002 determines whether a first message is transmitted on a first channel according to at least whether there exists an incomplete beam failure recovery procedure, the first message indicates the first reference signal resource;

herein, a transmission of the first message is for the beam selection management.

In one embodiment, the determining whether a first message is transmitted on a first channel according to at least whether there exists an incomplete beam failure recovery procedure comprises: if there does not exist incomplete beam failure recovery procedure, transmitting the first message on the first channel.

In one embodiment, the first transmitter 1002 transmits a second message, and the second message is used to indicate a second reference signal resource;

herein, the incomplete beam failure recovery procedure exists, and the transmitting a second message belongs to the incomplete beam failure recovery procedure; the determining whether a first message is transmitted on a first channel according to at least whether there exists an incomplete beam failure recovery procedure comprises: determining whether the first message is transmitted on the first channel based on whether the first reference resource and the second reference resource are non-QCL.

In one embodiment, the first transmitter 1002 initiates a first random access procedure, and the first random access procedure is based on contention; the first random access procedure comprises at least transmitting a first signal; the first signal comprises a first RACH preamble, and time-frequency resources occupied by the first RACH preamble is RACH resources associated with the second reference signal resource;

herein, the incomplete beam failure recovery procedure exists, and the first random access procedure belongs to the incomplete beam failure recovery procedure.

In one embodiment, the incomplete beam failure recovery procedure exists, and the determining whether a first message is transmitted on a first channel based on at least whether there exists an incomplete beam failure recovery procedure comprises: determining whether the first message is transmitted on the first channel based on whether the beam selection management is applied to a first search space set; the first search space set comprises at least one search space.

In one embodiment, the first receiver 1001 receives a third message, and the third message is used to indicate a first reference signal set; the first reference signal set comprises at least one reference signal resource; assesses first-type radio link quality according to the first reference signal set, whenever the assessed first-type radio link quality is worse than a first threshold, increases a first counter by 1; as a response to the first counter being greater than or equal to the first value, triggers the incomplete beam failure recovery procedure; assesses second-type radio link quality based on the first reference signal set; assesses third-type radio link quality based on a second reference signal set, and determines the first reference signal resource in the second reference signal set based on at least the second-type radio link quality and the third-type radio link quality.

In one embodiment, the first transmitter 1002 determines that the first message is transmitted on the first channel based on at least whether there exists an incomplete beam failure recovery procedure; the transmitting the first message on the first channel comprises transmitting the first message on the first channel after a first time window in which the incomplete beam failure recovery procedure is completed;

herein, the incomplete beam failure recovery procedure exists.

In one embodiment, the first transmitter 1002 transmits the first message on the first channel;

the first receiver 1001 receives a first signaling, the first signaling is used to confirm the first message; as a response to receiving the first signaling, cancels the incomplete beam failure recovery procedure;

herein, the incomplete beam failure recovery procedure exists.

In one embodiment, the first transmitter 1002 transmits the first message on the first channel;

the first receiver 1001, after the first message is transmitted, fails to monitor a PDCCH channel scrambled with a first RNTI on a first search space set within a second time window; applies the first reference signal resource;

herein, the beam selection management is applied to a first search space set; the first search space set comprises at least one search space.

In one embodiment, the first node is a UE.

In one embodiment, the first node is a terminal that supports large delay differences.

In one embodiment, the first node is a terminal that supports NTN.

In one embodiment, the first node is an aircraft.

In one embodiment, the first node is a vehicle terminal.

In one embodiment, the first node is a relay.

In one embodiment, the first node is a vessel.

In one embodiment, the first node is an IoT terminal.

In one embodiment, the first node is an IIoT terminal.

In one embodiment, the first node is a device that supports transmission with low-latency and high-reliability.

In one embodiment, the first node is a sidelink communication node.

In one embodiment, the first receiver 1001 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1002 comprises at least one of the antenna 452, the transmitter 454, the transmitting processor 468, the multi-antenna transmitting processor 457, the controller/processor 459, the memory 460 or the data source 467 in Embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but not limited to unmanned aerial vehicles, communication modules on unmanned aerial vehicles, tele-controlled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, satellite communication equipment, vessel communication equipment, NTN UEs, etc. The base station or system device in the present application includes but is not limited to macro-cellular base stations, micro-cellular base stations, home base stations, relay base station, gNB (NR node B), Transmitter Receiver Point (TRP), NTN base stations, satellite equipment, flight platform equipment and other radio communication equipment.

This application can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, for beam selection management, determining a first reference signal resource; and
a first transmitter, determining whether a first message is transmitted on a first channel according to at least whether there exists an incomplete beam failure recovery procedure, the first message indicating the first reference signal resource;
wherein a transmission of the first message is for the beam selection management.

2. The first node according to claim 1, wherein the determining whether a first message is transmitted on a first channel based on at least whether there exists an incomplete beam failure recovery procedure comprises: if there does not exist incomplete beam failure recovery procedure, transmitting the first message on the first channel.

3. The first node according to claim 1, comprising:
the first transmitter, transmitting a second message, and the second message being used to indicate a second reference signal resource;
wherein the incomplete beam failure recovery procedure exists, and the transmitting a second message belongs to the incomplete beam failure recovery procedure; the determining whether a first message is transmitted on a first channel according to at least whether there exists an incomplete beam failure recovery procedure comprises: determining whether the first message is transmitted on the first channel based on whether the first reference resource and the second reference resource are non-QCL (quasi-co-located).

4. The first node according to claim 2, comprising:
the first transmitter, transmitting a second message, and the second message being used to indicate a second reference signal resource;
wherein the incomplete beam failure recovery procedure exists, and the transmitting a second message belongs to the incomplete beam failure recovery procedure; the determining whether a first message is transmitted on a first channel according to at least whether there exists an incomplete beam failure recovery procedure comprises: determining whether the first message is transmitted on the first channel based on whether the first reference resource and the second reference resource are non-QCL.

5. The first node according to claim 3, comprising:
the first transmitter, initiating a first random access procedure, and the first random access procedure being based on contention; the first random access procedure comprising at least transmitting a first signal; the first signal comprising a first RACH (Random Access CHannel) preamble, and time-frequency resources occupied by the first RACH preamble being RACH resources associated with the second reference signal resource;
wherein the incomplete beam failure recovery procedure exists, and the first random access procedure belongs to the incomplete beam failure recovery procedure.

6. The first node according to claim 4, comprising:
the first transmitter, initiating a first random access procedure, and the first random access procedure being based on contention; the first random access procedure comprising at least transmitting a first signal; the first signal comprising a first RACH preamble, and time-frequency resources occupied by the first RACH preamble being RACH resources associated with the second reference signal resource;
wherein the incomplete beam failure recovery procedure exists, and the first random access procedure belongs to the incomplete beam failure recovery procedure.

7. The first node according to claim 1, wherein the incomplete beam failure recovery procedure exists, and the determining whether a first message is transmitted on a first channel based on at least whether there exists an incomplete beam failure recovery procedure comprises: determining whether the first message is transmitted on the first channel based on whether the beam selection management is applied to a first search space set; the first search space set comprises at least one search space.

8. The first node according to claim 1, wherein the incomplete beam failure recovery procedure exists, and the determining whether a first message is transmitted on a first channel based on at least whether there exists an incomplete beam failure recovery procedure comprises: determining whether the first message is transmitted on the first channel based on whether the beam selection management is applied to a first search space set; the first search space set comprises at least one search space.

9. The first node according to claim 1, comprising:
the first receiver, receiving a third message, the third message being used to indicate a first reference signal set; the first reference signal set comprising at least one reference signal resource; assessing first-type radio link quality according to the first reference signal set, whenever the assessed first-type radio link quality is worse than a first threshold, increasing a first counter by 1; as a response to the first counter being greater than or equal to a first value, triggering the incomplete beam failure recovery procedure; assessing second-type radio link quality based on the first reference signal set; assessing third-type radio link quality based on a second reference signal set, and determining the first reference signal resource in the second reference signal set based on at least the second-type radio link quality and the third-type radio link quality.

10. The first node according to claim 2, comprising:
the first receiver, receiving a third message, the third message being used to indicate a first reference signal set; the first reference signal set comprising at least one reference signal resource; assessing first-type radio link quality according to the first reference signal set, whenever the assessed first-type radio link quality is worse than a first threshold, increasing a first counter by 1; as a response to the first counter being greater than or equal to the first value, triggering the incomplete beam failure recovery procedure; assessing second-type radio link quality based on the first reference signal set; assessing third-type radio link quality based on the second reference signal set, and determining the first reference signal resource in the second reference signal set based on at least the second-type radio link quality and the third-type radio link quality.

11. The first node according to claim 1, comprising
the first transmitter, determining that the first message is transmitted on the first channel based on at least whether there exists an incomplete beam failure recovery procedure; the transmitting the first message on the first channel comprising transmitting the first message on the first channel after a first time window in which the incomplete beam failure recovery procedure is completed;
wherein the incomplete beam failure recovery procedure exists.

12. The first node according to claim 2, wherein
the first transmitter, determining that the first message is transmitted on the first channel based on at least whether there exists an incomplete beam failure recovery procedure; the transmitting the first message on the first channel comprising transmitting the first message on the first channel after a first time window in which the incomplete beam failure recovery procedure is completed;
wherein the incomplete beam failure recovery procedure exists.

13. The first node according to claim 1, wherein
the first transmitter, transmitting the first message on the first channel; and
the first receiver, receiving a first signaling, the first signaling being used to confirm the first message; as a response to receiving the first signaling, cancelling the incomplete beam failure recovery procedure;
wherein the incomplete beam failure recovery procedure exists.

14. The first node according to claim 2, wherein
the first transmitter, transmitting the first message on the first channel; and
the first receiver, receiving a first signaling, the first signaling being used to confirm the first message; as a response to receiving the first signaling, cancelling the incomplete beam failure recovery procedure;
wherein the incomplete beam failure recovery procedure exists.

15. The first node according to claim 3, wherein
the first transmitter, transmitting the first message on the first channel; and
the first receiver, receiving a first signaling, the first signaling being used to confirm the first message; as a response to receiving the first signaling, cancelling the incomplete beam failure recovery procedure;
wherein the incomplete beam failure recovery procedure exists.

16. The first node according to claim 1, wherein
the first transmitter, transmitting the first message on the first channel; and
the first receiver, after the first message is transmitted, failing to monitor a PDCCH (Physical Downlink Control Channel) channel scrambled with a first RNTI (Radio Network Temporary Identifier) on a first search space set within a second time window; applying the first reference signal resource;
wherein the beam selection management is applied to a first search space set; the first search space set comprises at least one search space.

17. The first node according to claim 2, wherein
the first transmitter, transmitting the first message on the first channel; and
the first receiver, after the first message is transmitted, failing to monitor a PDCCH channel scrambled with a first RNTI on a first search space set within a second time window; applying the first reference signal resource;
wherein the beam selection management is applied to a first search space set; the first search space set comprises at least one search space.

18. The first node according to claim 3, wherein
the first transmitter, transmitting the first message on the first channel; and
the first receiver, after the first message is transmitted, failing to monitor a PDCCH channel scrambled with a first RNTI on a first search space set within a second time window; applying the first reference signal resource;
wherein the beam selection management is applied to a first search space set; the first search space set comprises at least one search space.

19. The first node according to claim 13, wherein
the first transmitter, transmitting the first message on the first channel; and
the first receiver, after the first message is transmitted, failing to monitor a PDCCH channel scrambled with a first RNTI on a first search space set within a second time window; applying the first reference signal resource;
wherein the beam selection management is applied to a first search space set; the first search space set comprises at least one search space.

20. A method in a first node for wireless communications, comprising:
for beam selection management, determining a first reference signal resource;
determining whether a first message is transmitted on a first channel according to at least whether there exists an incomplete beam failure recovery procedure, the first message indicating the first reference signal resource;
wherein a transmission of the first message is for the beam selection management.
